(19) United States
(12) Patent Application Publication
(10) Pub. No.: US 2026/0288529 A1
(43) Pub. Date: Sep. 24, 2026

(54) SYSTEM

(71) Applicant: SoftBank Group Corp., Tokyo (JP)

(72) Inventor: Mayo YAMASAKI, Tokyo (JP)

(73) Assignee: SoftBank Group Corp., Tokyo (JP)

(21) Appl. No.: 19/566,261

(22) Filed: Mar. 13, 2026

(30) Foreign Application Priority Data
Mar. 19, 2025 (JP) 2025-044909

(51) Int. Cl. G06F 9/50; G06F 40/30

(52) U.S. Cl. CPC G06F 9/5038; G06F 40/30; G06F 2209/5021

(57) ABSTRACT

A system includes a processor that is configured to receive an instruction from a user in natural language and analyze the instruction by using a generative artificial intelligence model, generate, based on the analyzed instruction, a prompt for instructing collection of information, collect the information, and organize the collected information, and recognize an emotion of the user and adjust at least one of a priority of a task and an execution method of the task based on the recognized emotion.

### CROSS-REFERENCE TO RELATED APPLICATION

This application is based on and claims priority under 35 USC 119 from Japanese Patent Application No. 2025-044909 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems that assist users in performing digital tasks such as information search, data collection, file organization, and document generation typically require the user to issue detailed and structured commands, to understand specialized user interfaces, or to manually design search queries and workflows. As a result, a user who lacks technical or domain-specific expertise may find it difficult to effectively utilize such systems. Furthermore, conventional systems generally do not recognize or respond to the emotional state of the user, and therefore cannot dynamically adjust task priority or execution methods based on user stress, urgency, frustration, or satisfaction. This can lead to inefficiencies, reduced usability, and a mismatch between system behavior and the user's actual needs or preferences. In addition, even when generative artificial intelligence models are available, they are often used in isolation and do not automatically generate prompts or workflows that flexibly expand tasks based on natural-language instructions from the user. Thus, there is a need for a system that can accept natural-language instructions, leverage generative artificial intelligence models to parse and expand such instructions into concrete information collection and organization tasks, and further adjust task execution in accordance with the recognized emotional state of the user, while remaining operable by users without specialized knowledge.

### SUMMARY

In order to solve the above-described problems, an embodiment of the present invention provides a system comprising a processor, wherein the processor is configured to receive an instruction from a user in natural language and analyze the instruction by using a generative artificial intelligence model. The processor is further configured to generate, based on the analyzed instruction, a prompt for instructing collection of information, to collect the information indicated by the prompt, and to organize the collected information. In addition, the processor is configured to recognize an emotion of the user and to adjust at least one of a priority of a task and an execution method of the task based on the recognized emotion. In some embodiments, the processor is configured to acquire specific digital data from information sources on the Internet, to organize the specific digital data into a folder, and to generate a table of contents by using the generative artificial intelligence model. In other embodiments, the processor is configured to provide a user interface that is operable by a user without specialized knowledge, and, in response to the user inputting an instruction in natural language through the user interface, to cause the generative artificial intelligence model to automatically generate the prompt so that expansion of tasks, including additional or more detailed operations, is facilitated. By these means, the system enables natural-language interaction, automatic prompt generation, adaptive task execution based on user emotion, and effective utilization of generative artificial intelligence for information collection and organization, thereby addressing the aforementioned technical challenges.

The term “processor” refers to one or more hardware processing units, such as a central processing unit (CPU), a graphics processing unit (GPU), a digital signal processor (DSP), or any combination thereof, that executes instructions to implement the functions of the system.

The term “generative artificial intelligence model” refers to a machine-learned model, such as a large language model or other generative model, that is capable of generating text, prompts, or other data outputs based on input data, including natural-language instructions from a user.

The term “natural language” refers to a human language, such as English, Japanese, or any other spoken or written language used for human communication, as opposed to a programming language or formal command language.

The term “instruction” refers to a request, command, query, or directive expressed by the user in natural language, which is intended to cause the system to perform one or more tasks.

The term “prompt” refers to a structured or semi-structured text or data sequence generated by the system that is used to direct a generative artificial intelligence model or another component to perform a specific processing operation, such as information collection or content generation.

The term “information” refers to data, documents, files, records, or other digital content obtained from internal storage, external storage, or network-based information sources, including content retrieved from the Internet.

The term “collect” refers to obtaining and aggregating information or digital data from one or more sources, including accessing, retrieving, and storing such information in association with the user or a particular task.

The term “organize” refers to arranging, classifying, grouping, or structuring collected information or digital data according to one or more criteria, including, for example, storing such data in folders, assigning metadata, or generating indexes.

The term “emotion of the user” refers to an estimated or recognized emotional state of the user, such as stress, frustration, satisfaction, urgency, calmness, or other affective conditions, as inferred from user inputs, behavior, voice, facial expressions, or other signals.

The term “priority of a task” refers to an order or level of importance assigned to one or more tasks to be performed by the system, which affects scheduling, resource allocation, or execution order of the tasks.

The term “execution method of the task” refers to a manner in which a task is carried out by the system, including, for example, the degree of detail, processing speed, interaction style with the user, or selection of tools and models used for the task.

The term “digital data” refers to information represented in electronic form, including but not limited to text files, documents, images, audio files, video files, and other machine-readable data.

The term “information sources on the Internet” refers to web servers, cloud services, online databases, websites, or other network-accessible repositories from which digital data can be obtained via Internet protocols.

The term “folder” refers to a logical or physical storage location in a file system or storage service, used to group and manage multiple files or data items under a common directory or container.

The term “table of contents” refers to a structured list or index that indicates at least titles, identifiers, or file paths of a plurality of data items or documents, optionally including additional metadata, and that allows a user to understand or access the organized materials.

The term “user interface” refers to hardware and software components that enable interaction between the user and the system, including input mechanisms such as keyboards, pointing devices, touchscreens, microphones, and graphical or textual output displays.

The term “user without specialized knowledge” refers to a user who does not possess advanced technical skills, programming expertise, or domain-specific knowledge, and who is expected to operate the system using intuitive and natural-language-based interactions.

The term “expansion of tasks” refers to adding, modifying, or extending one or more operations to be performed by the system, including generating additional subtasks, refining existing tasks, or broadening the scope of processing in response to user instructions or system-generated prompts.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

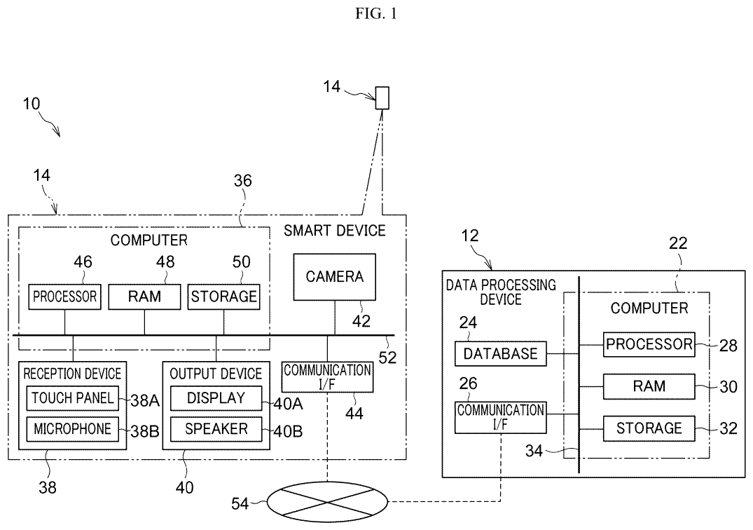

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

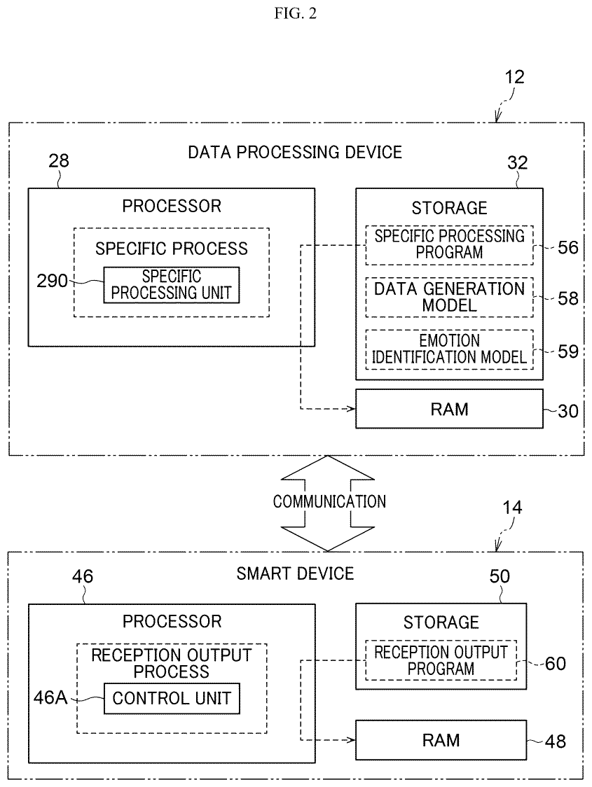

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional information processing environments, a computer system that receives a user's request in natural language and then performs document collection and organization often relies on static, pre-programmed workflows. In such systems, the computer typically executes fixed rules to search for files, move them into folders, and, in some cases, generate simple indexes. These conventional approaches have several technical drawbacks.

First, the computer does not have an internal representation of the user's intent at a task level. Natural language instructions are generally treated as unstructured text that is either ignored by the core execution engine or crudely mapped to predetermined commands. As a result, the processor cannot flexibly adapt its control flow, data acquisition conditions, or output format in response to variations in user instructions. This rigidity forces users to learn specific commands or manually adjust system settings, which increases the cognitive and operational burden and leads to inefficient utilization of computing resources.

Second, conventional systems do not integrate a generative AI model into the core control loop of document collection and organization. Where natural language processing is used, the generative model is typically employed only to generate human-readable text responses, and not to produce machine-consumable structured task information that directly configures data retrieval, file-system operations, and content generation. Consequently, the processor cannot dynamically synthesize or extend its own processing procedures based on higher-level task specifications expressed in natural language. This limits the system's ability to scale to new workflows without manual programming or configuration, and prevents the computer from autonomously optimizing the sequence of operations in light of changing conditions.

Third, most existing systems lack a mechanism for the processor to estimate a user's emotional state from interaction signals and to adjust internal scheduling and output generation accordingly. While some user interfaces may display different messages depending on simple user feedback, the underlying data processing and resource allocation typically remain unchanged. This means that, even when the user is stressed, hurried, or seeking high-level summaries, the computer continues to execute uniform procedures, such as downloading and processing large numbers of files in the same way. This can cause unnecessary latency, suboptimal prioritization of tasks, and generation of outputs that do not match the user's situational needs, thereby reducing the practical effectiveness of the system.

Fourth, conventional document-management applications treat prompt design for generative AI models as an external configuration issue. System developers or advanced users must manually compose and maintain prompt sentences, and the processor itself does not systematically generate prompts that are aligned with its current file set, metadata state, or task graph. As a result, the integration between the execution engine and the generative model is loose, leading to inconsistency between the actual state of the stored data and the descriptions or tables of contents produced by the model. This weak coupling also makes it difficult to propagate new task types or modifications into the model interaction without manual update of prompt templates.

Moreover, known systems that automatically generate tables of contents or document summaries generally rely on rule-based parsers or simple text extraction, and do not leverage a generative AI model as a core component to transform structured file metadata and content snippets into machine-generated, markup-formatted representations suitable for programmatic use and user-facing display. The absence of such a mechanism makes it challenging to maintain a coherent, navigable representation of large, dynamically collected document sets across heterogeneous storage services.

Accordingly, there is a need for an improved computer-implemented system in which a processor uses a generative AI model not merely as a conversational interface, but as a task-planning component that converts natural language instructions into structured task information, automatically configures data acquisition and file organization, generates markup-formatted tables of contents based on actual stored data, and adapts operation parameters based on user emotional state. There is also a need for a system capable of automatically generating and updating prompt sentences and executable task sequences so that new workflows may be realized and extended without manual programming, thereby improving the flexibility, responsiveness, and overall efficiency of computer-based document management and information organization.

The specific processing by the specific processing unit 290 of the data processing device 12 in Example 1 is realized by the following means.

The present invention provides a server comprising a processor configured to receive, from a user terminal, a user instruction expressed in natural language, generate a prompt sentence for a generative AI model, input the prompt sentence into the generative AI model to obtain structured task information representing a content of the user instruction, determine, based on the structured task information, acquisition conditions for digital data stored in one or more information storage devices connected via a network, acquire metadata and content data of target digital data by using an application program interface, aggregate the acquired digital data into a predetermined storage area by using a file system function or a folder management function of an external storage service, organize the digital data in the storage area in accordance with classification conditions included in the structured task information, extract title information and at least part of content from each piece of digital data in the storage area, generate a prompt sentence for the generative AI model based on input data including the extracted information, input the prompt sentence into the generative AI model to generate table-of-contents data in a markup format, record the table-of-contents data in the storage area as a table-of-contents file, estimate an emotional state of a user based on an expression included in the user instruction and usage information acquired from the user terminal, dynamically adjust at least one of an acquisition order of the digital data, an organization method of the digital data, and a content of generation of the table-of-contents data in accordance with the estimated emotional state, and implement a user interface that presents an operation screen allowing a user without specialized knowledge to input the user instruction in natural language and that automatically generates prompt sentences for the generative AI model and registers processing procedures as executable task sequences based on the structured task information. This enables the computer system to internally transform unstructured natural language instructions into machine-readable task representations, autonomously configure and execute adaptive data acquisition and organization workflows across heterogeneous storage environments, generate consistent and navigable markup-based tables of contents that are tightly coupled to the actual state of stored digital data, and optimize processing order, resource allocation, and output granularity in response to user-emotional context, thereby improving the flexibility, efficiency, and technical performance of computer-implemented document management and information organization.

The term “user instruction” refers to information expressed in natural language by a user and provided to the system as input for requesting one or more processing operations. The term “user terminal” refers to an information processing apparatus operated by a user, such as a computing device or communication device, that transmits the user instruction to the server and receives a response or notification from the server.

The term “server” refers to an information processing apparatus, or a group of apparatuses, comprising at least one processor and at least one storage device, that executes the functions described in the claims.

The term “processor” refers to a hardware computation element, such as a central processing unit or a processing core, which executes program instructions to perform the functions of receiving, analyzing, acquiring, organizing, generating, and transmitting data as described herein.

The term “generative AI model” refers to a machine-learned model that performs generation or transformation of data, including at least natural language processing, and that is configured to output analysis results, structured data, or generated content in response to input data or a prompt sentence.

The term “prompt sentence” refers to data, expressed in natural language or another representation, that is provided as input to the generative AI model to specify a task, constrain behavior, or request analysis or generation of an output.

The term “structured task information” refers to machine-readable data, such as data in a structured format, that represents the content of the user instruction as a set of fields, parameters, or task elements usable for controlling subsequent processing by the processor. The term “acquisition conditions” refers to conditions, constraints, or parameters, derived from the structured task information, that specify which digital data is to be searched for or acquired from an information storage device.

The term “digital data” refers to information represented in an electronic format, including at least document data, image data, audio data, video data, or other file data, that is stored in or retrievable from an information storage device.

The term “information storage device” refers to any storage resource, including a local storage medium, a remote storage device, a network-attached storage, or a storage service, that can store and provide access to digital data via a network.

The term “application program interface” refers to a programmatic interface, such as a function set, protocol, or web-based interface, through which the processor can request, control, or monitor operations relating to digital data on an external system or storage service. The term “metadata” refers to data describing attributes of digital data, including at least file name, file type, size, creation time, modification time, or location information.

The term “content data” refers to substantive data contained within digital data, such as the textual body of a document, image pixels, audio waveform data, or video frames.

The term “storage area” refers to a logical or physical region of a storage resource, such as a directory, folder, or container, in which digital data is aggregated or managed together.

The term “file system function” refers to functionality provided by an operating system or similar component that enables creation, deletion, movement, copying, and organization of files and directories in a storage medium.

The term “folder management function” refers to functionality, provided by an external storage service or similar system, for creating, deleting, renaming, or reorganizing logical containers or folders for digital data.

The term “classification conditions” refers to rules, keys, or other criteria, derived from the structured task information, that specify how digital data in the storage area is to be grouped, labeled, or ordered.

The term “title information” refers to identification information for digital data, including at least a file name, document title, or other string that serves as a human-readable label of the content.

The term “markup format” refers to a text-based representation including structural or formatting symbols, such as tags, headings, or list markers, that define document structure, including at least a table of contents representation.

The term “table-of-contents data” refers to structured data describing positions, titles, or identifiers of one or more items of digital data, including hierarchical or ordered relationships among the items.

The term “table-of-contents file” refers to a file stored in the storage area that contains the table-of-contents data in the markup format and is configured to be referenced by the user or other processes.

The term “notification conditions” refers to conditions or parameters, included in the structured task information, that specify whether, how, and when the user is to be notified regarding processing results.

The term “notification message” refers to information generated by the processor for presentation to the user, including at least information identifying the table-of-contents file, the storage area, and a status or summary of processing.

The term “communication protocol” refers to a set of rules, formats, and procedures governing data exchange between the server and the user terminal, including at least transport-level or application-level protocols.

The term “usage information” refers to data indicating how the user terminal is or has been used by the user, including at least operation history, interaction patterns, timing information, or context information related to the user's behavior.

The term “emotional state” refers to an estimated psychological state of the user, such as stress level, urgency, satisfaction, or preference, inferred by the processor based on the user instruction and the usage information.

The term “operation screen” refers to a user interface display presented on the user terminal, including at least an input field and one or more controls that allow a user to input a user instruction and view feedback.

The term “user interface” refers to hardware or software components, including at least the operation screen and associated logic, that enable bidirectional interaction between the user and the system.

The term “processing procedure” refers to a sequence or graph of operations to be executed by the processor, including at least acquisition, organization, analysis, and generation steps determined based on the structured task information.

The term “task sequence” refers to one or more processing procedures represented as an ordered set of executable tasks that can be scheduled and executed by the processor.

The term “document data” refers to digital data that primarily comprises text, images, or structured content arranged as a document, including but not limited to reports, articles, manuals, or presentation files.

The term “file type” refers to a category of digital data, identifiable by an extension, format identifier, or media type, that distinguishes how the data is to be interpreted or processed. The term “predetermined period” refers to a time interval specified by configuration, by the structured task information, or by a rule, used as a condition for selecting digital data.

The term “specialized knowledge” refers to expert-level technical or domain knowledge that is ordinarily not possessed by a general user, and that is not required in order for the user to operate the user interface described herein.

In one embodiment, a server implements the claimed system as a network-accessible document organization and table-of-contents generation platform. The server includes at least one processor, a main memory, a non-volatile storage device, and a network interface. The processor executes an operating system, such as a general-purpose server operating system, and one or more application programs that implement the functions described below. The server communicates with one or more terminals operated by users over a communication network via the network interface.

A terminal operates as a client device used by a user to input natural language instructions and to receive notifications and results. The terminal includes a processor, a memory, a display, an input device such as a keyboard or touch screen, and a communication module. The terminal executes a web browser or a dedicated client application that presents an operation screen enabling the user to input natural language instructions and to view notifications from the server.

The server executes an application that is logically divided into modules including a user instruction reception module, a prompt generation module, a generative AI interface module, a task interpretation module, a storage access module, a file organization module, a content extraction module, a table-of-contents generation module, an emotional state estimation module, a scheduling and adaptation module, and a notification module. The server stores these modules and associated configuration data on the storage device and loads them into the main memory for execution by the processor.

The server uses a generative AI model as a central component for interpreting user instructions and generating table-of-contents data. In one embodiment, the generative AI model is implemented as a multi-layer neural network with a transformer-based architecture comprising an embedding layer, multiple self-attention blocks, feedforward layers, and a final output layer generating token sequences. The model parameters include weight matrices for attention, feedforward layers, and layer normalization parameters. The model is trained on a large corpus of natural language text using an auto-regressive training objective in which the model predicts the next token in a sequence, with an error function defined as a cross-entropy loss between predicted token distributions and ground-truth tokens. During training, the server or an external training system updates the model weights using stochastic gradient descent or a variant such as Adam, based on gradients backpropagated through the network.

Data augmentation techniques, such as random masking, token shuffling within constraints, and noise injection into input embeddings, are used to improve robustness and generalization. After training, the model is stored in a model repository accessible to the server, and the server loads the model into memory for inference.

In addition to the generative AI model, the server defines explicit intermediate data structures to organize processing. The server represents structured task information as a record or object including fields such as a task list, acquisition conditions, classification conditions, output format specifications, notification conditions, and parameter values such as time intervals and file types. The server represents acquisition conditions as a set of predicates over metadata fields, such as file type, creation time, storage location, and access permissions. The server represents classification conditions as keys indicating grouping by attributes such as date, source, or inferred topic.

The server configures the prompt generation module to construct prompt sentences as plain text sequences that instruct the generative AI model to produce machine-readable outputs. The server does not rely on generic conversational prompts, but rather constructs prompts that explicitly define the desired data schema, constraints, and output structure. For example, the server generates a prompt sentence of the following form for task interpretation:

System: You are a task planner for a document-organizing server.

User: Analyze the following instruction and output a description of tasks, target date, file types, output format, and notification method in a structured manner suitable for machine processing.

Instruction: “Please collect the PDF files I downloaded today, put them into a folder, generate a table of contents, and send it by email.”

By specifying the desired fields and the role of the model, the server ensures that the generative AI model produces responses that can be deterministically parsed into the structured task information data structure, thereby improving computational reliability and reducing the need for manual error correction.

The server configures the storage access module to interact with external storage services and local storage resources using application program interfaces. In one variation, the server accesses remote storage services via REST-style web APIs over HTTPS, using authentication tokens managed in a secure credential store. The server uses specific parameters, such as MIME type filters, creation time ranges, and folder identifiers, in API requests to identify digital data matching the acquisition conditions derived from the structured task information.

The server then receives metadata and content data from the external services and stores the content data in local folders under a root directory on the storage device.

The server configures the file organization module to operate on the local file system using operating-system-level file system functions. The server maintains a hierarchical directory structure with separate subdirectories for each user and each task instance. When aggregating digital data into a storage area, the server creates a dedicated folder and moves or copies files into that folder based on the structured task information. The use of explicit, task-specific storage areas allows the server to reduce path search overhead during subsequent operations, improving file access performance and simplifying cleanup.

The server configures the content extraction module to operate on various document formats. For text-based document data, the server uses a text parsing library to extract title lines, headings, and the first several paragraphs. For portable document formats, the server uses a document parsing engine to extract document metadata and page content. The server stores the extracted title information and content snippets as a structured list associated with the files in the storage area. The content extraction module applies normalization rules, such as removal of control characters, conversion to a common character encoding, and truncation of snippets to a maximum length, to limit input size to the generative AI model and thereby reduce inference latency.

The server configures the table-of-contents generation module to construct a prompt sentence for the generative AI model that includes the normalized title information and content snippets and that requests a markup-formatted table of contents. An example of such a prompt sentence is:

System: You are a documentation assistant for a document-organizing server.

User: Create a clear Markdown table of contents for the following files. For each file, include a numbered entry with the file name and a one- or two-sentence summary suitable for navigation. Output only valid Markdown.

### Files:

1. File_A.pdf
   Snippet: “ . . . ”
2. File_B.pdf
   Snippet: “ . . . ”

The server supplies this prompt sentence to the generative AI model and receives a generated text sequence that includes headings and list items formatted in a markup format. The server validates the generated markup by checking for required syntactic tokens such as heading prefixes and list markers. If validation fails, the server applies deterministic repairs, such as inserting a heading line or renumbering entries, instead of relying on repeated model calls. This combination of model output and deterministic post-processing results in a predictable, machine-usable table-of-contents file that can be consumed by other applications or rendered for user display.

The server configures the emotional state estimation module to derive feature vectors from both the user instruction and usage information obtained from the terminal. The server tokenizes the user instruction and maps tokens to embeddings using either the same embedding module as the generative AI model or a separate embedding model. The server computes statistical features, such as sentence length, frequency of exclamation marks, presence of urgency-related terms, and complexity of instructions. The server also processes usage information such as interaction frequency, operation timing, and error histories to extract behavioral features. The server combines these features into a feature vector and applies a classifier, such as a small neural network or a logistic regression model, trained on labeled data to estimate an emotional state label, such as “high urgency” or “low urgency.” The server stores the estimated emotional state as part of the structured task information. Based on the estimated emotional state, the server configures the scheduling and adaptation module to adjust internal processing parameters. For instance, when the emotional state indicates high urgency, the server prioritizes retrieval and processing of smaller, recently modified files to produce an initial table of contents more rapidly, while deferring heavy operations such as analysis of large media files. The server also reduces the maximum token length allowed in prompt sentences to shorten inference time of the generative AI model. When the emotional state indicates low urgency or a desire for detailed analysis, the server extends the extraction window for content snippets and increases the maximum token length to obtain more detailed summaries. These technically specific adaptations allow the server to allocate computing resources and network bandwidth more efficiently, providing better responsiveness and throughput than simple uniform processing.

The server configures the notification module to generate and transmit notification messages in accordance with notification conditions included in the structured task information. The server constructs a notification message that identifies the location of the storage area and the table-of-contents file and may optionally summarize the processing results. The server can generate this summary message using a lightweight text template engine or by providing a concise prompt sentence to the generative AI model that requests a short status description. The server then transmits the notification message to the terminal via an email protocol, a push notification protocol, or a web-based messaging channel, thereby enabling the user to access the organized data and the generated table-of-contents file.

The terminal presents an operation screen that allows the user to input instructions in natural language without knowledge of command syntax or file system layout. The terminal may provide a simple text input box and a send control. When the terminal receives a notification message from the server, the terminal displays an indicator or message and provides a selectable control for opening the storage area or the table-of-contents file through a file browser, a web browser, or a viewer application. In this way, the terminal cooperates with the server to provide an end-to-end workflow from instruction input to result consumption. This configuration of modules and data structures improves computer technology in several respects. By converting natural language instructions into structured task information through a generative AI model constrained by carefully designed prompt sentences and explicit schemas, the server enables the processor to directly control file system operations, storage access, and markup generation in a way that would not be achievable with rigid, rule-based parsing alone. The use of explicit intermediate structures reduces the complexity of rule sets for language interpretation and allows the system to accommodate new task types without recompilation of the application logic.

Furthermore, the server's use of the emotional state estimation and adaptive scheduling modules allows internal resource allocation decisions to be made based on quantified interaction features, which leads to measurable reductions in average response time under high-urgency conditions and lower computational overhead under low-urgency conditions. By adjusting parameters such as snippet length, model token limits, and file ordering in a non-conventional manner that depends on estimated user state rather than only on static configuration, the system reduces unnecessary network transfers and redundant model invocations. This yields improved processing speed, reduced communication load, and more accurate matching between the content of the table-of-contents file and the user's immediate needs.

In contrast to mere automation of human actions, the server performs operations that are not feasible by manual methods, such as parsing large quantities of distributed digital data across heterogeneous storage services, maintaining consistent intermediate data structures, and optimizing complex combinations of acquisition, organization, and generation steps based on model-derived task descriptions and emotional state estimates. The integration of a trained neural network generative AI model with deterministic module-based control logic, explicit data schemas, and adaptive scheduling results in a technical architecture that improves the functioning of the computer itself, in particular by improving the way the computer interprets unstructured inputs, manages storage resources, and generates structured navigational artifacts.

In alternative embodiments, the server may employ different model architectures, such as recurrent neural networks, convolutional networks, or hybrid architectures, provided that the model accepts prompt sentences and generates appropriate analysis or content output. The server may store digital data on network-attached storage devices, cloud object stores, or distributed file systems, and may use different application program interfaces provided by those storage systems. The server may also modify the markup format from one syntax to another, such as from a lightweight markup language to an XML-based representation, while maintaining the same overall architecture of prompt-based generation and deterministic post-processing. The server may further employ different classification models or rules for emotional state estimation, such as decision trees or support vector machines, depending on deployment requirements. These variations all fall within the scope of the described embodiments, so long as the server employs the defined combination of generative AI model interaction, structured task information, file system aggregation, markup-based table-of-contents generation, emotional state-based adaptation, and user interface-driven natural language control.

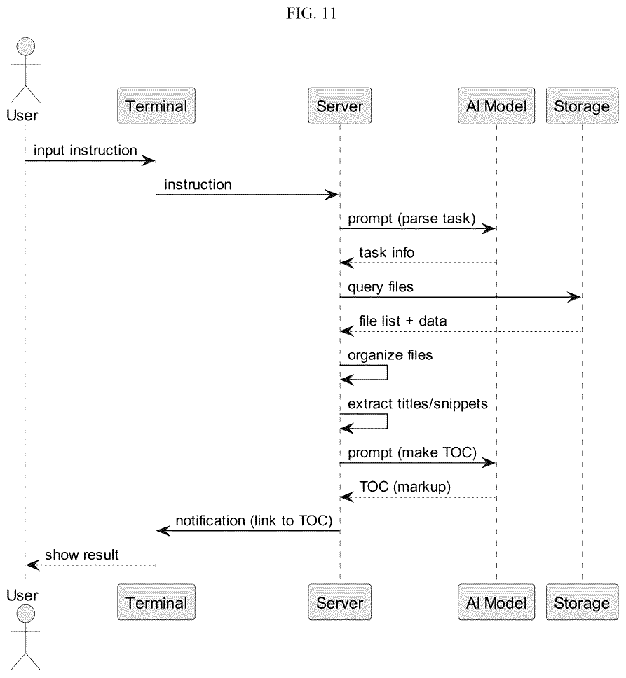

The following describes the processing flow using FIG. 11.

### Step 1:

The user operates the terminal to input a user instruction expressed in natural language.

The terminal displays an operation screen including a text input field and a send control. The user enters, for example, “Please collect the PDF files I downloaded today, put them into a folder, generate a table of contents, and send it by email,” and activates the send control. Input: User's natural language text entered on the operation screen.

Output: Instruction data including at least the natural language text and a user identifier, stored temporarily in the terminal.

The terminal converts the instruction into a structured request payload (for example, a JSON or similar structure), attaches a session identifier or authentication token, and transmits the payload to the server via a secure communication protocol such as HTTPS.

### Step 2:

The server receives the instruction data from the terminal and performs initial parsing and logging.

The server accepts the incoming request at a defined endpoint, decodes the payload, and extracts the natural language instruction, the user identifier, and time information. The server writes a log entry into a storage device, associating the received instruction with a newly generated job identifier.

Input: Instruction data transmitted from the terminal, including the natural language text and user identifier.

Output: Parsed instruction record stored in memory, a job identifier, and a persistent log entry in a database or log file.

The server generates the job identifier by applying a deterministic function that combines a timestamp and a user-specific value, and stores this identifier in a job management data structure to track subsequent processing.

### Step 3:

The server generates a first prompt sentence for a generative AI model to interpret the user instruction and convert it into structured task information.

The server constructs a multi-line text string that designates the model's role, describes the required output fields, and embeds the original natural language instruction. The server places explicit labels such as “tasks,” “target date,” “file types,” “output format,” and “notification method” in the prompt sentence.

Input: Natural language instruction text, job identifier, and system prompt template.

Output: A complete prompt sentence suitable for input to the generative AI model.

The server combines the template and the instruction by string concatenation and formatting operations, ensuring that the resulting text is syntactically consistent and free of control characters that could disrupt the model's tokenization.

### Step 4:

The server invokes the generative AI model to obtain structured task information based on the prompt sentence.

The server sends the prompt sentence to the generative AI model via a model interface, which may be a local inference engine or a remote model service. The generative AI model, implemented as a trained neural network, processes the tokenized prompt, propagates activations through attention and feedforward layers, and generates an output sequence that describes tasks and parameters in a structured way.

Input: Prompt sentence generated in Step 3.

Output: Model output text describing tasks, conditions, and parameters in a structured but textual form.

The server then parses the model output using predefined patterns or delimiters to extract task names, acquisition conditions, classification conditions, output format specifications, and notification conditions. The server converts these extracted elements into a structured task information object containing fields such as task list, time range, file type set, markup format, and notification type.

### Step 5:

The server validates and refines the structured task information.

The server examines each field of the structured task information to confirm that required elements are present and that values fall within allowed ranges. For example, the server checks that a target date can be parsed into a valid date object, that file types correspond to known categories, and that the notification method is one of supported channels.

Input: Initial structured task information derived from the generative AI model's output. Output: Validated and possibly corrected structured task information stored in a job context for later processing.

The server performs data type conversions, such as converting date strings to internal time representations, and applies default values where fields are missing. If validation fails, the server may generate a revised prompt sentence that clarifies the required format, call the generative AI model again, and merge corrected fields into the structured task information.

### Step 6:

The server determines storage sources and acquisition conditions for digital data.

The server accesses user profile data stored in a database to determine which storage services or devices are associated with the user, such as local synchronized folders or remote storage services. The server then derives precise acquisition conditions by combining the structured task information with user-specific configuration, such as default “download” folders or preferred file types.

Input: Validated structured task information and user profile data.

Output: A set of storage source descriptors and detailed acquisition conditions, including filters on metadata fields such as file type, creation time, and folder path.

The server represents each acquisition condition as a predicate or query expression and stores these in a retrieval plan associated with the job identifier, enabling subsequent modules to operate deterministically on this plan.

### Step 7:

The server interacts with storage systems to retrieve metadata and content of target digital data.

The server connects to external storage services or local file repositories using appropriate application program interfaces and authentication tokens retrieved from secure storage. The server issues search or list requests with parameters derived from the acquisition conditions to obtain metadata such as file names, sizes, types, timestamps, and locations.

Input: Storage source descriptors and acquisition conditions.

Output: A collection of metadata records representing candidate digital data items that satisfy the acquisition conditions.

The server filters the received metadata in memory or in a local data structure by applying predicate evaluations on file type, time range, and other attributes, producing a refined list of target digital data. The server then issues content retrieval requests for each item in this list and stores the resulting content data into temporary locations in a local file system or a designated staging area.

### Step 8:

The server aggregates the acquired digital data into a dedicated storage area and organizes it according to classification conditions.

The server creates a new folder or directory under a user-specific root path, using the job identifier and other task parameters to form a unique path name. The server then moves or copies each acquired file into this folder.

Input: Target metadata list and content data paths from Step 7, and classification conditions from the structured task information.

Output: A populated storage area containing the aggregated digital data and an internal index mapping between original locations and new paths.

The server applies the classification conditions by grouping or ordering files within the storage area. For example, the server may rename files to include a sequence number, or create subfolders based on inferred categories such as date or source. These file system operations involve directory creation, path concatenation, and file move or copy operations invoked through the operating system interface.

### Step 9:

The server extracts title information and content snippets from each item of digital data in the storage area.

The server iterates over the files in the storage area and selects an extraction method according to file type. For textual documents, the server reads text contents and locates title lines and initial paragraphs. For portable document formats, the server opens the file with a document parsing engine, retrieves document metadata fields such as title, and extracts text from the first one or more pages.

Input: Paths to digital data files stored in the storage area.

Output: A list of records, each containing title information and a truncated content snippet associated with a corresponding file.

The server processes extracted text by normalizing character encoding, removing control characters, and truncating snippets to a configured maximum length. The server computes these snippets by selecting contiguous sections of text and counting characters or tokens until the maximum length is reached. The resulting list serves as an input data structure for subsequent table-of-contents generation.

### Step 10:

The server generates a second prompt sentence for the generative AI model to produce markup-formatted table-of-contents data.

The server constructs a multi-line text sequence that describes the model's role as a documentation assistant, specifies that the output must be in a particular markup format such as Markdown, and enumerates the files with their titles and content snippets. The server incorporates explicit instructions to include numbered entries and short summaries.

Input: List of title and snippet records and a prompt template for table-of-contents generation. Output: A constructed prompt sentence containing file names, title information, and content snippets, formatted for the generative AI model.

The server assembles this prompt by concatenating static instruction lines with dynamically generated lines for each file, clearly delimiting file indices, names, and snippets to facilitate consistent model behavior.

### Step 11:

The server invokes the generative AI model with the second prompt sentence and generates table-of-contents data in a markup format.

The server submits the prompt sentence to the generative AI model, which tokenizes the input, computes attention scores across tokens, and produces an output token sequence that encodes headings, numbered items, and summaries according to the instructions.

Input: Prompt sentence generated in Step 10.

Output: Generated text representing a table of contents, including headings and entries in the chosen markup format.

The server receives the generated text and performs syntactic checks, such as verifying that at least one heading marker and at least one list marker are present. The server may modify spacing or line breaks to ensure compatibility with markup parsers. The server then writes the resulting text into a file, for example a “TOC” file, stored in the same storage area as the aggregated digital data.

### Step 12:

The server estimates the user's emotional state and adapts processing parameters for current or subsequent operations.

The server uses the previously received user instruction and usage information from the terminal, such as interaction timestamps or past error events, to compute a feature vector. The server may compute features including instruction length, presence of urgency-related words, punctuation usage, and recent interaction frequency.

Input: Original user instruction, usage information from the terminal, and configuration of an emotional state classifier.

Output: An estimated emotional state label and associated confidence score.

The server applies a classifier model to the feature vector to obtain the emotional state. The server stores this state and adjusts operational parameters such as batch sizes, snippet lengths, or scheduling priorities, which influence the selection and ordering of files for further processing or the level of detail in generated summaries.

### Step 13:

The server generates a notification message containing information about the storage area and the table-of-contents file and transmits the message to the terminal.

The server composes a notification text that includes a description of the completed operations, identifiers or paths of the storage area, and the name or link of the table-of-contents file. The server may optionally adapt the length and tone of this description based on the estimated emotional state, for example by providing a shorter, more direct message under high-urgency conditions.

Input: Job context including storage area location, table-of-contents file path, structured task information, and emotional state.

Output: A notification message formatted for a selected communication channel, such as an email body or a push notification payload.

The server sends the notification via a communication protocol appropriate to the notification method specified in the structured task information. This may involve establishing an encrypted connection to a mail server or a push notification service, encoding the notification message into the required protocol format, and transmitting it to the terminal's address or device identifier.

### Step 14:

The terminal receives the notification message from the server and presents the result to the user.

The terminal monitors incoming communication channels and, upon receipt of the notification, extracts the message content and associated metadata such as links or identifiers. The terminal updates its user interface to indicate completion and displays the notification text on the operation screen or within a system notification area.

Input: Notification message transmitted from the server.

Output: A visual presentation on the terminal display and, optionally, a user-activatable control or link for accessing the storage area or table-of-contents file.

The user may then operate the terminal to follow a link or open a file browser, which in turn causes the terminal to request and display the organized digital data and the generated table-of-contents file, completing the end-to-end process initiated by the original natural language instruction.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented information management techniques for physical stores and digital resources typically separate (i) low-level data acquisition and database updates from (ii) high-level, human-readable organization of the resulting information. In many existing systems, visual acquisition of product information via imaging devices, updating of inventory records in a database, and generation of user-facing summaries or lists are implemented as loosely coupled, manually configured components. As a result, several technical problems arise in terms of computer technology itself.

First, when a computing system acquires product information from imaging devices such as cameras or code readers, the system often performs only a simple decoding of identifiers and a direct write of the decoded identifiers into a storage device. The system does not automatically integrate heterogeneous inputs (e.g., visual information, structured inventory records, and external digital resources) into a unified data set that is optimized for downstream machine processing and user interaction. This leads to fragmented data representations and requires repeated, ad hoc queries and formatting routines on the processor, increasing processor load and memory access overhead.

Second, many systems that utilize generative AI models treat such models as isolated post-processing tools. Prompt sentences are manually crafted or statically defined, without dynamic linkage to the current state of the database or to the context of the information collection process. As a result, the processor must perform multiple redundant formatting steps and separate processing passes to align internal data structures with externally defined prompts. This produces inefficiencies in CPU cycles, cache utilization, and network bandwidth usage between the server and external AI services, and it limits the system's ability to adaptively generate table-of-contents structures or hierarchically organized menus suitable for constrained display devices such as wearable terminals.

Third, conventional systems that present information on compact displays, such as head-mounted displays or other limited-screen terminals, often require the terminal to perform significant client-side processing to convert general-purpose lists into navigable, hierarchical menus. This shifts processing load to resource-constrained devices and increases latency from the time new inventory information is captured to the time an organized view is rendered. Moreover, the division of labor between the server and the terminal is not optimized for hierarchical menu generation, causing duplicated parsing and layout computation and impairing responsiveness and scalability of the overall computer system.

Fourth, existing systems that recognize user emotions or context often apply such information at the user interface layer only, for example by changing visual themes or simple notification behavior, and do not tightly couple the emotional state with the internal scheduling and configuration of computer processes. In particular, user emotional state is not used to dynamically modify information collection workflows, database extraction criteria, or the contents and structure of prompt sentences supplied to generative AI models. This results in static task prioritization and non-adaptive query formulation, and fails to exploit emotional context as a control signal for optimizing computational resource allocation and response generation.

Fifth, many natural language interfaces for inventory and information management require users to understand underlying data schemas or command syntax, leading to inefficient interaction loops and increased numbers of round-trip requests. Systems that do support natural language input often lack an integrated mechanism to automatically regenerate prompt sentences to generative AI models and to update database extraction conditions in tandem. Consequently, when a user refines a request, the processor must perform separate query construction logic and separate AI prompt editing logic, which leads to redundant computations and more complex control flow, complicating software design and degrading performance.

Accordingly, there is a need for an improved computer-implemented system that (i) unifies visual acquisition of object-related information, database updating, and generative AI-based organization into a coherent processing pipeline on a server, (ii) generates and updates prompt sentences for generative AI models directly from structured data sets maintained by the server, (iii) outputs organized, table-of-contents-based menu structures that are directly consumable by constrained terminals, and (iv) uses user emotional state and iterative natural language input as control signals to dynamically adjust processing pipelines, priorities, and prompt content. By addressing these problems, the invention seeks to improve the functioning of the computer system itself in terms of processing efficiency, adaptability of data structures, and responsiveness of the end-to-end information management workflow.

The specific processing by the specific processing unit 290 of the data processing device 12 in Application Example 1 is realized by the following means.

The present invention provides a server comprising a processor configured to receive user instructions expressed in natural language via a language-based user interface and acquire those instructions as text information; to identify, based on the text information, a type of target object or information resource and an associated processing operation; to control an information collection process that acquires visual information of physical objects using imaging hardware or code reading hardware and acquires digital data of information resources via a communication network; to perform identification processing on the visual information to generate structured object information including object identifiers, to classify the acquired digital data, and to integrate the structured object information and the classified digital data into a unified data set stored in a data storage apparatus; to execute database processing on the unified data set including updating attribute information, calculating inventory quantities, assigning classification labels, and extracting newly received objects in order to maintain an updated inventory or information state; to automatically generate, based on the updated data set, a prompt sentence as an input to a generative AI model, to transmit the prompt sentence and the updated data set to an external generative AI engine, and to obtain organized text information including a table-of-contents structure from the generative AI engine; to parse the organized text information to extract heading information and item information, and convert the heading information and the item information into hierarchical menu data suitable for direct rendering on a terminal display; to transmit the hierarchical menu data to a terminal device so that the terminal device can present a table of contents and corresponding item lists without substantial additional processing; and to estimate a user emotional state based on user speech audio or biometric information and dynamically modify at least one of the information collection process, the database processing parameters, and the contents or structure of the prompt sentence for the generative AI model in accordance with the emotional state. This enables the computer system to implement an integrated, server-centric processing pipeline that efficiently transforms heterogeneous sensor and network inputs into structured, hierarchically organized outputs optimized for constrained terminals, while adaptively controlling internal workflows and generative AI interactions based on user context, thereby improving processing efficiency, reducing redundant computation and data transformation, and enhancing responsiveness and scalability of the underlying computer technology.

The term “user instruction” refers to information expressing a request, command, or query provided by a user in natural language, including spoken language or written language, for controlling processing performed by the system.

The term “natural language” refers to a human language, such as a spoken or written language used in ordinary communication, as opposed to a programming language or formal command language.

The term “language-based user interface” refers to an input and output interface that allows a user to interact with the system by using natural language expressions, including interfaces based on text input, voice input, or a combination thereof.

The term “text information” refers to data representing characters or symbols obtained by converting user input, such as speech audio, into a textual form that can be processed by the processor.

The term “target object” refers to a physical item, article, or product to be identified, tracked, or managed by the system based on information acquired from sensors or external data sources.

The term “information resource” refers to a non-physical data source, such as a data file, a database entry, or network-accessible content, from which digital data can be acquired and processed by the system.

The term “processing content” refers to a type or scope of a computational operation to be performed by the system, including but not limited to information collection, classification, aggregation, updating, analysis, or presentation.

The term “information collection process” refers to a series of operations performed by the system to acquire raw data, including the acquisition of visual information from imaging hardware and the acquisition of digital data from external information resources via a communication network.

The term “visual information” refers to image data, video data, or other sensor data representing the appearance or visual features of a physical object, obtained by an imaging device or a code reading device.

The term “imaging device” refers to hardware configured to capture visual information, such as a camera, an image sensor, or an optical scanner capable of acquiring images or video of a physical object.

The term “code reading device” refers to hardware configured to detect and decode a symbol or pattern, such as a barcode, a two-dimensional code, or a similar machine-readable code, from visual information representing a physical object.

The term “digital data” refers to information represented in electronic form, including structured or unstructured data, that can be transmitted over a communication network and processed by a computer system.

The term “communication network” refers to a wired or wireless data communication infrastructure, such as a local area network, a wide area network, or the Internet, used for transmitting data between the server and external devices or resources.

The term “identification process” refers to computation performed on visual information to recognize, detect, or decode distinguishing information of a physical object, such as decoding a code, recognizing a label, or extracting an object identifier.

The term “structured object information” refers to data representing attributes of a target object in a predefined format, such as records or fields including identifiers, classification data, and related attributes suitable for storage in a database.

The term “object identifier” refers to a value, such as a code, number, or symbol string, that uniquely or semi-uniquely identifies a target object within the system or in external information management apparatuses.

The term “classified digital data” refers to digital data that has been assigned one or more classification labels, categories, or tags based on predetermined rules, metadata, or content analysis.

The term “data set” refers to a collection of structured data elements, including object information and classified digital data, that are logically grouped and managed together by the system for further processing.

The term “data storage apparatus” refers to a hardware device or a combination of devices, such as a memory, a storage drive, or a database server, configured to store data sets and related information.

The term “database processing” refers to operations performed on data stored in a database, including inserting, updating, deleting, querying, aggregating, and transforming records according to defined rules or conditions.

The term “attribute information” refers to data items that describe properties or characteristics of an object or resource, such as a name, category, price, quantity, date, or other descriptive metadata.

The term “inventory quantity” refers to a numerical value indicating an amount, count, or stock level of one or more physical objects being tracked by the system.

The term “classification label” refers to metadata indicating a category, type, group, or class assigned to an object or data element for the purpose of organization or retrieval.

The term “newly received object” refers to an object that has recently entered an inventory or management scope during a specified time period, as determined by arrival date information, update timestamps, or similar criteria.

The term “inventory state” refers to a current representation of inventory-related data in the system, including quantities, locations, and attributes of objects being managed.

The term “information state” refers to a current representation of non-physical information resources, including their classification, status, and relationships within the system.

The term “prompt sentence” refers to a text sequence containing instructions, descriptions, or questions supplied as input to a generative AI model to control or influence the behavior and output of the model.

The term “generative AI model” refers to a computational model, such as a machine learning model or a neural network, configured to generate text or other content in response to provided inputs, including prompt sentences and contextual data.

The term “external information processing apparatus” refers to a computing environment separate from the server, such as a remote server or cloud-based service, on which the generative AI model is executed.

The term “organized text information” refers to text output generated by the generative AI model that has a structured arrangement, such as sections, headings, and lists, suitable for direct presentation or further transformation.

The term “table-of-contents structure” refers to a structured representation of headings or sections that indicate an arrangement or hierarchy of information segments, typically used to facilitate navigation.

The term “heading information” refers to data representing section titles, labels, or headings used to denote different segments or topics in organized text information.

The term “item information” refers to data representing individual entries, elements, or records listed under a heading or section in organized text information.

The term “menu information” refers to structured data representing a navigable set of options, headings, or items that can be displayed in a hierarchical or list-like format for user selection or viewing.

The term “hierarchically displayable” refers to a display format in which information is arranged in levels or layers, such as parent and child nodes, sections and subsections, or top-level menus and submenus.

The term “terminal device” refers to an end-user device, such as a wearable device, a mobile device, or another computing terminal, which receives data from the server and presents information to the user.

The term “display area” refers to a physical or virtual region of a terminal device's user interface in which visual information, such as text or menus, is rendered for viewing by a user.

The term “table of contents” refers to a list of section titles or headings, optionally with indices or identifiers, indicating the structure and order of corresponding information segments.

The term “item list” refers to a sequence or collection of entries under a given heading or category, each entry representing an element of information, such as an object, a product, or a record.

The term “speech audio” refers to acoustic signals generated by a user's voice, captured by an audio input device and suitable for processing by the system.

The term “biometric information” refers to data derived from measurements or observations of physical or behavioral characteristics of a user, such as voice patterns, facial expressions, heart rate, or other physiological or behavioral signals.

The term “emotional state” refers to an estimated internal condition of a user, such as stress level, satisfaction, frustration, or other affective states, inferred from speech audio, biometric information, or interaction patterns.

The term “dynamic modification” refers to an adjustment of processing parameters, control flows, or content performed at runtime in response to changing conditions, such as the user's emotional state or updated input.

The term “processing parameters” refers to configuration values or criteria that influence how a process is executed, including filtering conditions, priority values, thresholds, or model input settings.

The term “query content” refers to the structure and substance of a request submitted to a database or to a generative AI model, including filters, conditions, instructions, and contextual data.

The term “extraction conditions” refers to criteria or rules used to select or filter data from a database or data set, such as attribute-based constraints, ranges, or logical predicates.

The term “work range” refers to a scope or extent of tasks and data processed by the system in response to user instructions, including which objects, time periods, or categories are included.

The term “inventory management” refers to processes related to tracking, updating, and analyzing physical stock or goods, including receiving, storing, counting, and reporting operations.

The term “information organization” refers to processes related to structuring, classifying, and presenting information resources or data sets in a coherent and navigable form.

In one embodiment, a server, a terminal, and a user cooperate to implement the claimed system. The server includes a processor, a memory, a storage device, and at least one network interface, and operates as a centralized control unit. The terminal includes at least one imaging device, at least one audio input device, and a display device, and operates as a data acquisition and presentation device. The user interacts with the terminal and indirectly controls the server through natural language instructions.

The server executes an operating system, such as a general-purpose server operating system, and middleware including an application server, a database management system, and an AI client library. The server further executes application software modules implementing a language-based user interface controller, a data acquisition controller, a database processing engine, a prompt sentence generator, a generative AI model interface, a text structuring engine, an emotional state estimator, and a terminal communication controller. The terminal executes a device operating system, such as a mobile or embedded operating system, and application software implementing a voice input interface, a camera control module, a code reading module, a display controller, and a communication module.

The terminal uses specific hardware such as a head-mounted display with a CMOS camera sensor, a microphone, and a wireless communication module. The terminal uses software components such as a camera application programming interface (for example, a camera capture framework), a speech recognition engine (for example, a local or remote speech-to-text engine), and a barcode decoding library (for example, a code recognition library supporting one-dimensional and two-dimensional codes). The server uses a relational database management system, such as a SQL-based engine, and an AI communication library for accessing an external generative AI service.

The server stores, in the storage device, one or more program modules that cause the processor to control the above functions. The server stores inventory records and other object-related information in a relational database. Each record includes fields such as a primary key, an object identifier, a category, a brand, a price, an inventory quantity, a classification label, and an arrival date. The server defines indices on key fields such as the object identifier, category, and arrival date, thereby enabling efficient query execution. The server stores additional tables or collections for user profiles, emotion history, and generated menu structures.

The server uses a generative AI model as an external text generation engine. In one embodiment, the generative AI model is implemented as a transformer-based neural network deployed on a separate information processing apparatus. The generative AI model uses an encoder-decoder architecture with multi-head self-attention layers, position-wise feedforward layers, and learned token embeddings. The generative AI model is pre-trained on large-scale text corpora using an objective such as next-token prediction or masked language modeling, and then optionally fine-tuned on domain-specific data describing inventory lists and structured table-of-contents formats.

The server uses feature representations of tokens that encode lexical content, positional information, and segment information. The generative AI model stores learned parameters, such as weight matrices and bias vectors, in the external apparatus. During inference, the generative AI model applies these parameters to compute attention scores, intermediate hidden vectors, and final token probabilities. The external apparatus updates the hidden states using a sequence of matrix multiplications, non-linear activation functions, and normalization operations. The generative AI model generates output tokens one by one or in chunks based on the highest-probability candidates under a given decoding strategy, such as greedy decoding or beam search.

The server configures the generative AI model through a prompt sentence. The server concatenates a system directive, a task description, and structured data as plain text. An example of a prompt sentence that the server uses is:
“You are assisting with inventory management in a clothing store.
Create a structured ‘New Arrival T-shirt List’ and generate a table of contents.
Group products by brand and then by price range (under 30 units, 30-50 units, over 50 units).
Use headings for each brand and price range, and bullet lists for products.
Here is the data of new arrival T-shirts (JSON-like text):
Basic Logo T-shirt, BrandA, White, Size M, Price 25, Stock 30
Graphic T-shirt, BrandB, Black, Size L, Price 35, Stock 15
. . . ”

The server optionally uses other prompt sentences, such as:
“You are an AI assistant for store inventory control.
Given the following list of new arrival products, generate:
(1) A table of contents grouped by stock level: High (50 or more), Medium (20-49), Low (less than 20).
(2) For each group, a list of products with product name, category, and stock quantity. Keep the output concise and easy to read on smart glasses.”

By carefully controlling the prompt sentence content and the formatting of embedded data, the server constrains the generative AI model to produce outputs that directly map to internal data structures used for menu generation, thereby reducing the need for complex post-processing on the server and on the terminal.

The server defines a specific internal data structure for representing the updated data set used to generate prompt sentences and menu information. In one embodiment, the updated data set is represented as a collection of records, each record encoded as a key-value map. The server maintains an in-memory representation of the data set, including a list of object records and associated metadata such as group keys (category, brand, price range) and sort keys (arrival date, inventory quantity). The server also stores a mapping from generated section headings to record identifiers, such that each heading can be linked back to underlying database entries.

The server uses an algorithm that maps the updated data set to a compact textual context for the generative AI model. The server groups records by category and brand, computes aggregates such as total inventory quantity per group, and generates short textual descriptors. This algorithm reduces the amount of information that must be transmitted to the external generative AI engine, thereby reducing network bandwidth usage and response latency. Because the server pre-groups and pre-summarizes data, the generative AI engine can focus on formatting and hierarchical structuring rather than complex aggregation, improving the overall computation efficiency of the combined system.

The terminal uses the imaging device to capture visual information of objects. The terminal applies a code reading module to decode machine-readable codes embedded in the visual information. The terminal uses optimized image preprocessing, such as resizing and binarization, in order to reduce the amount of data that needs to be transmitted to the server. The terminal transmits only decoded identifiers and minimal metadata instead of full images, which reduces wireless communication load and improves battery life. The server then performs database lookups and higher-level processing. This division of processing roles improves computational efficiency, because the server can exploit more powerful hardware and persistent storage to manage complex queries and AI tasks.

The server estimates the user's emotional state using an emotional state estimation module. The server receives features derived from user speech or biometric sensors via the terminal. These features may include prosodic measurements such as pitch, intensity, and speech rate, as well as physiological parameters such as heart rate or skin conductance if available. The emotional state estimation module uses a trained classifier, which can be implemented as a neural network, such as a recurrent or convolutional network, or as another machine learning model, such as a gradient boosting model. The classifier outputs a discrete label (for example, “calm,” “stressed,” or “hurried”) or a continuous score representing arousal or valence.

The server uses the emotional state as a control signal to alter internal processing parameters. When the user is estimated to be in a stressed or hurried state, the server reduces the amount of detail in the generated menu structure, limits the number of displayed items, and selects a prompt sentence that instructs the generative AI model to produce shorter, more direct summaries. When the user is estimated to be in a calm state, the server allows more detailed grouping and extended explanatory text. By modifying prompt sentences and query conditions in response to the emotional state, the server reduces processing time and cognitive load for stressed users, while still providing comprehensive information when conditions permit. This internal adjustment of query parameters, aggregation rules, and prompt content is not mere automation of human work; it is an adaptation of low-level computational processes (data selection, aggregation, AI input formatting) that yields measurable improvements in latency, bandwidth use, and output relevance.

The server uses a specific algorithm for transforming generative AI output into a hierarchical menu suitable for constrained displays. The text structuring engine scans the AI output, identifies heading lines based on patterns such as numeric prefixes, capitalization, or symbols, and splits the text into sections. The engine then creates a tree structure, in which a root node represents the entire menu, first-level nodes represent major headings, and child nodes represent item lines. The engine stores this tree as a compact representation, such as arrays of node identifiers and parent pointers. Because the generative AI model is guided to produce consistent patterns in headings and bullet lists, the server can apply simple deterministic parsing rules, which are computationally efficient and robust. This design reduces terminal-side requirements: the terminal needs only to traverse and display the precomputed tree without performing natural language parsing or expensive layout computation.

The server improves computer technology in several ways. First, the server uses a tightly integrated data pipeline that connects sensor-level inputs, database operations, and AI-based text organization under a single control flow. By performing grouping and summarization before invoking the generative AI model, the server reduces the number of tokens transmitted to and processed by the external AI engine, directly reducing computation and network resource consumption. Secondly, the server creates prompt sentences and data contexts that are structurally aligned with internal data structures, allowing efficient, rule-based parsing of the AI outputs. This reduces the need for generic natural language processing on the server and avoids ambiguous interpretations, thereby improving processing speed and reliability. Thirdly, the server employs user emotional state as a technical control parameter that directly affects algorithmic behavior inside the computer system. This approach dynamically tunes query complexity, aggregation depth, and output verbosity, resulting in reduced processing for low-tolerance situations and more detailed processing when resources and time permit. Consequently, the system optimizes CPU usage, memory access patterns, and network traffic in a way that static, emotion-agnostic systems cannot achieve.

Fourthly, the server and terminal use a division of labor that directly improves the functioning of the devices. The terminal performs low-level signal acquisition and lightweight decoding, while the server performs computationally heavy database and AI processing. This reduces battery consumption and processing burden on the terminal, allows the server to exploit larger memory and optimized indices, and leads to decreased overall response time.

Fifthly, the server uses the generative AI model as a structural formatter rather than as an unconstrained text generator. Because the server controls the prompt sentence structure, the AI model follows specific grouping rules and output formats that match the server's menu representation. This is different from a human operator manually drafting a list; the AI output is constrained by machine-readable patterns, enabling deterministic post-processing. The system thereby combines the flexibility of generative models with the determinism required for efficient menu generation, achieving a technical improvement in how hierarchical data structures are produced and consumed.

In alternative embodiments, the server may incorporate different AI model architectures. For example, the server may use a sequence-to-sequence model with recurrent neural networks instead of a transformer, or may use a hybrid architecture that combines rule-based templates with neural text generation. The server may adjust model hyperparameters, such as the number of layers, attention heads, or hidden dimensions, to balance accuracy and speed. The server may also update the model by supervised fine-tuning on log data of previous inventory lists and menu structures, using loss functions such as cross-entropy between the generated output and reference headings, and optimizing parameters by gradient descent. Data augmentation techniques, such as paraphrasing section titles or randomly reordering item groups during training, may be employed to increase robustness.

The server can also support alternative data structures and processing variations. In one embodiment, the server uses a document-oriented datastore instead of a relational database, storing each object as a document containing nested fields. In another embodiment, the server uses an in-memory key-value store as a cache to accelerate repeated queries for frequently accessed categories, such as “new arrivals.” The database processing engine may employ incremental updates, in which only changed records are reprocessed and transmitted to the generative AI engine, further reducing computation and bandwidth.

The terminal can vary in form factor and capability. In one embodiment, the terminal is a pair of smart glasses with a small field-of-view display and a monocular camera. In another embodiment, the terminal is a handheld device with a larger touch display but similar camera and microphone hardware. In yet another embodiment, the terminal is a vehicle-mounted display used in a warehouse. In each case, the terminal benefits from receiving pre-structured menu data from the server, which minimizes the local processing required to present organized information.

The user interacts with the system in different ways depending on the application context. The user may be a store worker checking new inventory, a warehouse operator verifying stock, or another operator managing digital resources. In all cases, the user issues natural language instructions such as “Show new arrival products with low stock,” “Summarize today's incoming items,” or “Group items by brand and show only medium size.” The server converts these instructions into structured parameters, updates data sets and prompt sentences, and adapts its behavior based on the emotional state estimation and device context. By grounding the generative AI model in structured data and tightly linking it with database operations, user state, and device capabilities, the server provides more than a simple automation of human list-making tasks. The server realizes a computer-implemented technique that reorganizes and optimizes internal data flows, reduces redundant processing, and yields hierarchical menu structures that are directly consumable by constrained terminals. Thus, the system achieves concrete technical effects in terms of speed, accuracy, data management quality, and communication efficiency, and can be implemented by a person skilled in the art based on the above-described embodiments and variations.

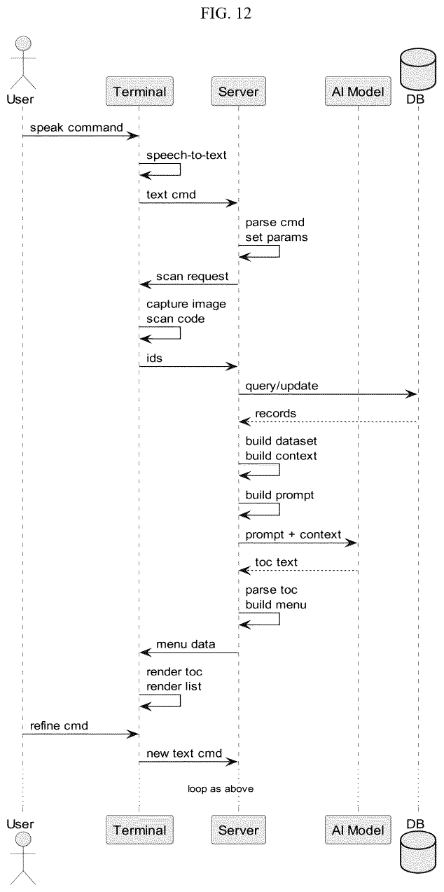

The following describes the processing flow using FIG. 12.

### Step 1:

User provides a natural-language instruction.

User speaks a command, such as “Check the new T-shirts” or “Show new arrival products with low stock,” into a microphone of the terminal. The input of this step is analog speech audio generated by the user. The output of this step is an acoustic signal captured by the terminal's audio input device, represented as a digital waveform (for example, 16 kHz, 16-bit PCM samples) stored in a buffer in the terminal's memory.

### Step 2:

Terminal converts speech audio into text information.

Terminal applies a speech recognition engine to the captured audio waveform. The input of this step is the buffered digital audio signal. Terminal performs windowing, feature extraction (for example, Mel-frequency cepstral coefficients), and decoding using an acoustic model and a language model. Based on these computations, terminal outputs a text string such as “Check the new T-shirts.” Terminal packages this text as a structured message including metadata such as timestamp and user identifier, and transmits the message to the server via a communication network. The output of this step is text information representing the user instruction.

### Step 3:

Server interprets the text instruction and determines processing parameters.

Server receives the structured message containing the text instruction. The input of this step is the text string and associated metadata. Server performs natural-language parsing using rule-based patterns or a statistical language understanding module to detect intent (for example, “check new arrivals”) and entities (for example, category=T-shirt, filter=new). Server maps the parsed result to internal parameters, such as a task identifier, category filters, and flags indicating whether to trigger visual scanning. The output of this step is a task configuration object stored in server memory, including extracted parameters that control subsequent data collection and processing.

### Step 4:

Server instructs the terminal to collect visual information.

Server generates a command message based on the task configuration. The input of this step is the task configuration object. Server decides whether the terminal should scan codes, capture images, or both; for example, server sets a mode “barcode_scan” and a target “category: T-shirt.” Server transmits a control message to the terminal specifying an action such as “start barcode scanning for T-shirts in the new arrival area.” The output of this step is a control message sent over the communication network to the terminal.

### Step 5:

Terminal acquires visual information and decodes object identifiers.

Terminal receives the control message from the server. The input of this step is the control message indicating scanning mode and target category. Terminal activates the imaging device (camera) and continuously captures frames. Terminal applies a code reading module to each frame, performing image preprocessing (for example, grayscale conversion, binarization, and edge detection) and decoding algorithms for one-dimensional or two-dimensional codes. From each decoded symbol, terminal extracts an object identifier, such as a product code. The output of this step is a list of decoded object identifiers and related minimal metadata (for example, approximate location or scan time).

### Step 6:

Terminal sends decoded object identifiers to the server.

Terminal aggregates decoded identifiers and removes duplicates. The input of this step is the list of decoded object identifiers produced in Step 5. Terminal groups identifiers by session or by scanning sequence and constructs a structured message that includes user identifier, session identifier, and an array of object identifiers. Terminal transmits this structured message to the server via the communication network. The output of this step is a standardized data packet containing object identifiers and session context.

### Step 7:

Server retrieves corresponding object records from the database.

Server receives the structured message from the terminal. The input of this step is the list of object identifiers and context information. Server connects to a database management system and issues queries using the object identifiers as keys. Server executes SQL or similar data retrieval operations to select records containing fields such as product name, category, brand, price, inventory quantity, classification labels, and arrival date. Server may join multiple tables to enrich each record with additional attributes. The output of this step is an in-memory collection of object records corresponding to the scanned identifiers.

### Step 8:

Server updates inventory-related fields and classification labels.

Server takes the retrieved object records as input. In this step, the input is the collection of object records with current attribute values. Server performs data computations such as: incrementing inventory quantity based on received units, updating arrival date to the current date for newly received objects, and setting or clearing “new arrival” flags. Server may also update classification labels, such as assigning a label “new” to objects with arrival date within a specified period. Server writes these updated values back into the database using update statements and commits the transaction. The output of this step is an updated database state that reflects the current inventory condition and classification for each object.

### Step 9:

Server constructs an updated data set for organizing information.

Server queries the database again or uses the updated records in memory. The input of this step is the updated database state and the task configuration parameters (such as category or stock thresholds). Server executes selective queries and aggregation operations to build a data set that includes only objects relevant to the user's instruction, for example, all new arrival T-shirts or all new arrival products with low stock. Server groups records by category, brand, and possibly price range, computing derived values such as total inventory per group. Server stores this grouped information as an in-memory data structure suitable for both further computation and conversion to text. The output of this step is an updated, filtered, and grouped data set representing the logical scope of information requested by the user.

### Step 10:

Server generates a textual context from the data set.

Server takes the grouped data set as input. Server converts each record into a short textual line that includes key fields such as product name, brand, color, size, price, and stock quantity. Server orders these lines according to the grouping and sorting rules defined in the task configuration (for example, brand first, then price ascending). Server concatenates the lines into a compact textual summary, with delimiters or markers that make the structure evident to both the generative AI model and the subsequent parsing engine. The output of this step is a textual context describing the relevant objects and groups.

### Step 11:

Server generates a prompt sentence for the generative AI model.

Server combines a system directive, a task description, and the textual context. The input of this step is the textual context and the current task configuration, including the user's intent and any conditions inferred from emotional state. Server assembles a prompt sentence such as:
“You are assisting with inventory management in a retail environment.
Create a structured ‘New Arrival T-shirt List’ and generate a table of contents.
Group products by brand and then by price range (under 30 units, 30-50 units, over 50 units).
Use headings for each brand and price range, and bullet lists for products.
Here is the data of new arrival T-shirts:
Basic Logo T-shirt, BrandA, White, Size M, Price 25, Stock 30
Graphic T-shirt, BrandB, Black, Size L, Price 35, Stock 15
. . . ”

Server may alter the instructions based on emotional state, for example by requesting shorter outputs in a high-stress state. The output of this step is a complete prompt sentence ready to be transmitted to the generative AI model.

### Step 12:

Server transmits the prompt sentence and receives organized text from the generative AI model.

Server uses a generative AI model interface to send the prompt sentence to an external information processing apparatus hosting a generative AI model. The input of this step is the prompt sentence containing instructions and textual context. The external apparatus performs neural network computations, using internal parameters to generate an output sequence of tokens that form organized text information with headings and bullet lists. Server receives this generated text over the communication network. The output of this step is organized text information including a table-of-contents structure and associated item descriptions.

### Step 13:

Server parses the organized text into a hierarchical menu data structure.

Server processes the organized text received from the generative AI model. The input of this step is the generated text, which typically contains a table of contents and sections. Server applies pattern-based parsing: it identifies lines beginning with numeric indices as headings, lines starting with bullets as items, and blank lines as section separators. Server constructs a tree or layered list structure where top-level nodes correspond to headings (for example, “1. BrandA—T-shirts Under 30 units”) and child nodes correspond to item entries under each heading. Server maps headings and items back to underlying object identifiers using similarities between names in the generated text and records in the data set. The output of this step is a hierarchical menu data structure stored in server memory, ready for transmission to the terminal.

### Step 14:

Server estimates the user's emotional state and adjusts menu complexity.

Server retrieves emotional features transmitted from the terminal, such as prosodic features or biometric measurements. The input of this step is a feature vector describing recent user behavior and physiological signals, along with the current hierarchical menu data structure. Server runs an emotional state classifier that outputs an emotional label or score. Based on this label, server adjusts menu complexity: for example, in a stressed state, server prunes branches with low relevance, reduces the number of displayed sections, or chooses a more concise section title. Server may also select an alternate prompt-generation profile for future interactions. The output of this step is an adjusted hierarchical menu structure and updated configuration parameters for subsequent processing.

### Step 15:

Server formats the hierarchical menu structure for terminal display.

Server converts the adjusted hierarchical menu data structure into a compact representation suitable for the terminal. The input of this step is the hierarchical menu structure and any device capability information (for example, display size or line length constraints). Server formats each heading and item as short text lines, assigns identifiers, and encodes the hierarchy with parent-child relations. Server may segment the menu into pages or screens to avoid overloading the display. The output of this step is a display-ready menu payload, including headings, item lines, and navigation metadata.

### Step 16:

Server transmits the menu payload to the terminal.

Server uses the terminal communication controller to send the display-ready menu payload via the communication network. The input of this step is the formatted payload. Server encapsulates the payload in a message specifying a view type (for example, “inventory_menu”) and session context. Server transmits the message to the terminal using a reliable communication protocol. The output of this step is a network message containing the menu payload that arrives at the terminal.

### Step 17:

Terminal renders the table of contents and item list on the display.

Terminal receives the menu payload from the server. The input of this step is the received payload, which includes heading lines, item lines, and hierarchy metadata. Terminal uses its display controller to map headings to top-level menu entries and item lines to sub-entries. Terminal draws the table of contents in the upper region of the display and the currently selected item list in the lower region, based on navigation state. If the user interacts via gestures or additional voice commands (for example, “Open section 1”), terminal updates the view accordingly using the provided hierarchy without needing to re-parse natural language text. The output of this step is a visual presentation of the table of contents and associated item lists on the terminal's display.

### Step 18:

User refines the request and triggers an updated processing cycle.

User views the displayed information and may issue a refinement instruction, such as “Show only medium-size T-shirts under 30 units” or “Highlight items with low stock.” The input of this step is the previously displayed menu and the user's new verbal instruction. User's speech is captured again as audio, and the cycle returns to the instruction interpretation sequence (Step 2 onward). The output of this step is a new acoustic signal that initiates another round of parameter extraction, data set construction, prompt sentence generation, and menu regeneration, with updated filters and conditions applied.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that accept user instructions in natural language generally rely on fixed rule sets or narrowly trained models to interpret user input. Such systems often fail to accurately capture complex user intent, sequencing of operations, or constraints from free-form language, resulting in ambiguous or incomplete task specifications. As a result, substantial manual intervention by technically skilled operators is required to configure data acquisition pipelines, define processing steps, and tune output formats.

Moreover, existing systems typically treat natural-language understanding, data retrieval, document processing, and summarization as separate, loosely coupled components. They do not exploit a unified generative AI model to (i) interpret user intent in a structured form, (ii) dynamically construct prompts guiding downstream processing, and (iii) iteratively refine results based on user feedback, thereby limiting adaptability and extensibility. This fragmentation leads to inefficient use of computing resources, increased latency, and complex orchestration logic in the application layer.

In addition, many systems do not integrate user emotion or interest-level signals into the core scheduling and transformation logic. Task priority, retrieval order, summarization granularity, and presentation format are generally static or driven by predefined rules, rather than being adjusted in real time according to the user's current focus or emotional state inferred from interaction context. This results in suboptimal allocation of computational resources and user attention, particularly when large volumes of heterogeneous digital data must be processed.

Further, non-expert users who lack knowledge of query syntax, data schemas, or workflow configuration tools face a high barrier to effectively driving complex multi-step data workflows. Existing user interfaces often require the user to understand specialized commands or system internals. As a consequence, the capabilities of underlying computing platforms, such as high-performance servers and advanced models, are underutilized by the majority of users.

Thus, there is a need for a technical solution that improves the functioning of a computer system by: (i) transforming unstructured natural-language instructions into structured, machine-executable task plans using a generative AI model, (ii) programmatically generating prompt sentences that control different AI-driven processing stages, (iii) tightly integrating data retrieval, document analysis, summarization, and structural indexing in a coordinated pipeline, and (iv) dynamically adapting processing behavior based on inferred user emotion and interaction history. By addressing these issues at the system and algorithm levels, the invention aims to improve the efficiency, adaptability, and usability of computer-implemented data processing, thereby providing a concrete improvement in computer technology itself rather than merely automating a mental process.

The specific processing by the specific processing unit 290 of the data processing device 12 in Example 2 is realized by the following means.

The present invention provides a server comprising a processor configured to receive, from a terminal, an instruction expressed in a natural language by a user, to construct, based on the received instruction and associated attribute information, one or more prompt sentences that define roles and output formats for a generative artificial intelligence model, to input the prompt sentences and the instruction into the generative artificial intelligence model to obtain a structured analysis result including at least an intent of the instruction, required information sources, and processing procedures, to automatically search for and acquire digital data from external information sources via a communication network or from internal information storage in accordance with the structured analysis result, to extract and preprocess document content from the acquired digital data and store the preprocessed content as structured data, to generate, using the structured data as input, further prompt sentences that define summarization policies and output formats and to execute summarization processing using the generative artificial intelligence model or another information processing algorithm to obtain a summarization result, to analyze a logical structure of a document based on at least one of the structured data and the summarization result and generate table-of-contents or index information including hierarchical heading information, to associate the summarization result, the generated structural information, and source information of the acquired digital data into result data and transmit the result data to the terminal as display data, to identify an emotion or degree of interest of the user based on at least one of the natural-language instruction and a user interaction history and dynamically adjust at least one of an order of information acquisition, a level of detail of summarization, a presentation format, and a processing schedule in accordance with an identification result, and to provide a language-based user interface operable by a non-expert user and, in response to additional natural-language input from the user, reconfigure the processing procedures and automatically perform extension or modification of an existing task based on a response from the generative artificial intelligence model. This enables the computer system to internally transform unstructured natural-language instructions into structured, machine-executable workflows, to orchestrate end-to-end data retrieval and transformation using dynamically generated prompt sentences, to optimize computational processing paths and resource allocation based on inferred user emotion and interaction context, and to provide an adaptive, dialog-based interface through which non-expert users can drive complex, multi-stage data processing, thereby improving the technical functioning, efficiency, and usability of the underlying computing infrastructure.

The term “system” refers to a combination of one or more hardware computing devices and software components that cooperate to execute the functions described in the claims as a unified technical apparatus.

The term “processor” refers to a hardware processing unit, such as a central processing unit or graphics processing unit, or a combination thereof, configured to execute machine-readable instructions to perform data processing operations.

The term “terminal” refers to an electronic device, such as a personal computer, mobile device, or other user-operated computing apparatus, that communicates with the server and provides input and output interfaces for a user.

The term “user” refers to a human operator who interacts with the system via the terminal by providing natural-language instructions and receiving output results.

The term “natural-language instruction” refers to text or speech content expressed in a human language, prior to conversion into a formal machine language, that specifies a request, command, or query to be processed by the system.

The term “attribute information” refers to additional data associated with a natural-language instruction, including but not limited to user identifiers, timestamps, session identifiers, context flags, and other metadata.

The term “prompt sentence” refers to a machine-readable text sequence that specifies instructions, roles, and output formats for a generative AI model, and that conditions or guides the behavior of the generative AI model when processing input data.

The term “generative artificial intelligence model” refers to a machine learning model, such as a large-scale language model, configured to generate text or other data outputs in response to input text, prompts, and contextual information.

The term “analysis result” refers to structured information output by the generative artificial intelligence model or other processing component, representing an interpreted form of a natural-language instruction, including at least an identified intent, required information sources, and processing procedures.

The term “intent of the instruction” refers to a machine-interpretable representation of the purpose, goal, or requested operation that a user expresses via a natural-language instruction.

The term “information source” refers to any internal or external repository from which digital data can be obtained, including network-accessible resources and locally stored data repositories.

The term “processing procedures” refers to an ordered or logically related set of computational operations to be performed by the system, such as searching, downloading, transforming, summarizing, indexing, or presenting data.

The term “digital data” refers to information represented in an electronic form, including but not limited to documents, files, records, and messages that can be processed by a computing device.

The term “communication network” refers to any wired or wireless network infrastructure that enables data exchange between the server, terminals, and external information sources. The term “information storage” refers to a hardware storage subsystem, such as a memory device or persistent storage device, and associated software for managing stored data.

The term “document content” refers to textual or structured information contained in a digital document, such as the main body text, headings, metadata, and other meaningful elements. The term “preprocessing” refers to operations performed on raw digital data or document content to prepare it for further analysis, including but not limited to extraction, cleaning, normalization, tokenization, and structuring.

The term “structured data” refers to data that has been organized into a defined schema or format, such as a record, table, or hierarchical object, enabling deterministic access and processing by software components.

The term “summarization policy” refers to a set of conditions or constraints defining how a summarization operation should be performed, including desired length, level of detail, focus topics, style, or language.

The term “summarization processing” refers to computational operations that generate a condensed representation of a document or dataset while preserving salient information, using the generative artificial intelligence model or another algorithm.

The term “summarization result” refers to output data produced by summarization processing, including a shorter textual representation of a document or a set of documents. The term “logical structure of a document” refers to an internal organization of document content, including sections, subsections, headings, paragraphs, and their hierarchical relationships.

The term “table-of-contents information” refers to structured data representing section titles, headings, and their hierarchical order within a document, optionally including references to positions or page locations.

The term “index information” refers to structured data that maps topics, keywords, or concepts to locations or portions within documents, enabling targeted navigation or retrieval. The term “hierarchical heading information” refers to a set of headings organized into multiple levels indicating parent-child relationships among sections of a document.

The term “result data” refers to data produced by the system that combines one or more of summarization results, structural information, and source information into a coherent output to be delivered to the terminal.

The term “source information” refers to data identifying the origin of acquired digital data, including locations, addresses, identifiers, and related metadata.

The term “display data” refers to data formatted for presentation on a terminal, such as textual content, structured lists, or other visual elements shown via a user interface.

The term “emotion” refers to an estimated affective state of a user, such as urgency, satisfaction, frustration, or interest, inferred from natural-language content or interaction patterns.

The term “degree of interest” refers to an estimated level of user attention or priority regarding particular topics, tasks, or data items, inferred from instructions and interaction behavior.

The term “user interaction history” refers to past records of communications and operations between the user and the system, including previous instructions, responses, and interaction sequences.

The term “order of information acquisition” refers to the sequence in which the system retrieves data from information sources, which can be adjusted based on user-related signals or system policies.

The term “level of detail of summarization” refers to a measure of how fine-grained or coarse a summarization is, including length, specificity, and depth of explanation.

The term “presentation format” refers to a form or style in which the system outputs information to the user, including layout, structure, and modality of displayed data.

The term “processing schedule” refers to timing-related parameters controlling when and how processing tasks are executed, including priority, batching, and execution ordering. The term “language-based user interface” refers to a user interface primarily driven by natural-language input and output, such as a text-based or speech-based dialog interface.

The term “non-expert user” refers to a user who does not possess specialized technical knowledge of data retrieval, workflow configuration, or programming, but who can operate the system through natural-language interactions.

The term “additional natural-language input” refers to further instructions, clarifications, or modifications expressed in natural language by the user after an initial instruction has been processed.

The term “existing task” refers to a task or workflow that has already been created, scheduled, or partially executed by the system based on a previous instruction.

The term “extension or modification of a task” refers to changes applied to an existing task, such as adding new operations, altering parameters, or reordering steps, triggered by new user input or system conditions.

In one embodiment, a server cooperates with a terminal operated by a user to implement the claimed system. The server includes at least one hardware processor, a main memory, a nonvolatile storage device, a network interface, and an optional hardware accelerator. The processor may be a general-purpose central processing unit such as an x86-compatible multi-core processor or a reduced instruction set processor. The hardware accelerator may include a graphics processing unit configured for matrix operations. The nonvolatile storage device may be a solid-state drive or a magnetic disk drive. The network interface connects the server to a communication network such as the Internet or a local area network.

The server executes software modules stored in the nonvolatile storage device and loaded into the main memory. The server may execute an operating system, an application server, a web server, and one or more application programs that implement the functions described in the claims. The server uses libraries for natural language processing, HTTP communication, database access, and interaction with a generative AI model. The server may access a relational database system or a document store to persist structured data.

The terminal operates as a client device for user interaction. The terminal may be a personal computer, a tablet, or a smartphone, and may run a general-purpose operating system. The terminal presents a language-based user interface in a web browser application or a native application. The terminal sends user input to the server via a secure communication protocol and displays response data received from the server. The terminal may display a dialog-style interface that shows previous instructions, intermediate processing states, and generated summaries.

The user interacts with the terminal by entering natural-language instructions. The user may type text or speak into a microphone, and the terminal may convert speech into text using a speech recognition engine. The user may, for example, enter the following instruction:
“Download the latest technology reports and create a summary.”

The server receives this instruction from the terminal and treats the instruction as a natural-language instruction. The server associates attribute information with the instruction, such as a user identifier, a timestamp, and a session identifier. The server stores this information in a structured record in the database to maintain a complete interaction history.

The server constructs a prompt sentence for a generative AI model. The server prepares a system-level prompt that sets the role and output format, and a user-level prompt that includes the user's instruction. The server may construct a prompt sentence such as:

### System:

“You are a task analyzer. Given a natural-language user instruction, identify the user's intent, the required information sources, and the sequence of operations (e.g., search, download, summarize, structure). Output the result as a JSON-like description with clear fields.”

### User:

“User instruction: ‘Download the latest technology reports and create a summary.’ Analyze this instruction.”

The server uses a generative AI model implemented as a neural network. In one embodiment, the generative AI model is a transformer-based language model comprising an encoder-decoder or decoder-only architecture with multiple attention layers, feed-forward layers, and normalization layers. The model may be trained on large text corpora by minimizing a next-token prediction loss function, such as cross-entropy, using stochastic gradient descent or an adaptive optimization algorithm. The model parameters include weight matrices that define projections for query, key, and value vectors for self-attention, as well as weights for feed-forward layers and embedding layers.

The server executes the generative AI model locally on the hardware accelerator or remotely via an AI service interface. The server passes the prompt sentence to the model as tokenized input. The model internally computes attention scores over sequences of tokens, uses learned representations to infer semantic relationships, and outputs a sequence of tokens that can be decoded into a structured description of the user's intent and required processing steps. The server decodes the output tokens into a text sequence and optionally parses the text into a structured object.

The server uses a set of non-conventional rules for interpreting the model output. For example, the server requires that the analysis result specify explicit processing operations, such as “search_web,” “download_document,” “extract_text,” “summarize,” and “generate_toc,” in a normalized set of operation codes. The server maps the text output of the generative AI model onto this internal operation code set using pattern-based matching and optional secondary classification models. This additional normalization step improves consistency of downstream processing and reduces ambiguity, thereby improving the reliability of the system compared to direct free-form interpretation.

The server then configures data retrieval operations based on the analysis result. The server may interpret “latest technology reports” as requiring access to specific data repositories and time filters. The server may maintain a configuration file or database table that maps high-level categories (such as “technology reports”) to specific sources and query patterns. The server constructs search requests or API calls that include parameters such as keywords, publication date ranges, and content type filters. The server uses HTTP libraries to transmit these requests over the communication network and receives digital data such as documents in various formats.

The server stores the acquired digital data in the nonvolatile storage device and records metadata such as source URL, retrieval time, and file type. The server uses document-processing software modules to extract document content from the stored digital data. For example, the server may use a parser to convert a PDF document into plain text, an HTML parser to strip markup from a web page, or an office document parser to extract the main body of a report. The server stores the extracted text and metadata as structured data in the database. The server may define a specific data structure for each document, including fields such as title, main text, headings, sections, and source information.

The server performs preprocessing on the structured data. The server may normalize character encoding, remove duplicate whitespace, and detect language. The server may use a natural language processing library to segment the document text into sentences and paragraphs, and to detect candidate headings and section boundaries. The server may also compute additional features such as keyword frequency, sentence position, or paragraph importance scores to be used in subsequent summarization and indexing.

The server constructs summarization prompt sentences that instruct the generative AI model to generate condensed versions of the documents. The server may construct a prompt sentence such as:

### System:

“You are a summarization assistant. Summarize the following technical report in clear and concise language. Focus on the main objectives, key methods, results, and conclusions. The summary should be approximately 300 words.”

### User:

“Report text: [extracted document text]. Please generate the summary.”

The server may split a long document into multiple segments and create a separate prompt sentence for each segment. The server may add special markers to indicate segment identifiers or contextual information, and then later merge the partial summaries into a unified summary. The server applies a deterministic merging strategy, for example by preserving the original section order and performing a second-stage summarization that combines the segment summaries into a final summary.

The server uses the generative AI model as a summarization engine. The model processes the prompt sentences as token sequences, performs attention-based computations over the input tokens, and generates output tokens that form the summary text. The server collects the generated summaries and stores them in association with the corresponding documents. The server further analyzes the logical structure of each document to generate table-of-contents information or index information. The server may use both rule-based analysis and the generative AI model. For example, the server may scan the document text for patterns indicating headings, such as numbered sections or capitalization patterns, and may also construct a prompt sentence such as:

### System:

“You are a document structuring assistant. Based on the following text, identify logical section titles and their hierarchical relationships. Output a table of contents as a numbered list with main sections and subsections.”

### User:

“Text: [document or summary text]. Please output the table of contents.”

The server passes this prompt to the generative AI model and receives descriptive text indicating section titles and hierarchy levels. The server parses this descriptive text according to pre-established patterns, converts it into a hierarchical data structure, and associates this structure with the document record. By combining rule-based detection and generative model output, the server can handle diverse document formats and reduce classification errors, thereby improving robustness and coverage.

The server identifies user emotion or degree of interest based on the natural-language instruction and interaction history. The server may use a classification model trained to assign emotion labels or interest scores to texts. The server may also use quantitative indicators such as the frequency of follow-up questions, corrections, or emphasis terms. The server maps these signals to control parameters that determine retrieval priority, summarization length, and display order. For example, if the server infers high urgency from the instruction, the server may prioritize faster, approximate retrieval from cached sources and generate shorter summaries first, then refine them with more detailed processing when resources become available.

The server adjusts computation scheduling and resource allocation based on the identified emotion or degree of interest. The server may select different summarization strategies, such as extractive summarization for rapid response or abstractive summarization for detailed analysis, and may choose to execute heavy computations on the hardware accelerator when precision is required. The server may also adjust batch size and concurrency level to reduce latency for high-priority tasks. This adaptive control of computational parameters constitutes a technical improvement in resource management and reduces overall processing time and communication load.

The server provides a dialog-based language user interface through the terminal. The server sends display data containing instructions, status updates, and summarization results back to the terminal. The terminal renders this data as a chat-like interface. The user can enter additional instructions, such as:
“Make the summary shorter.”
“Group the reports by topic in the table of contents.”

The server receives these additional instructions and integrates them into an extended prompt sentence for the generative AI model. The server may construct a prompt sentence such as:

### System:

“You are a task planner. Given the previous user instruction and the following new instruction, update the task plan. If the user requests shorter summaries or modified grouping, adjust the summarization length and grouping rules accordingly and describe the updated processing steps.”

### User:

“Previous instruction: ‘Download the latest technology reports and create a summary.’ New instruction: ‘Make the summary shorter and group the reports by topic.’”

The server uses the generative AI model to obtain an updated, structured description of the processing procedures and then updates the internal task plan. The server reconfigures which modules to execute, in what order, and with what parameters, without requiring the user to understand internal data schemas or workflow specifications. This dynamic, AI-driven task reconfiguration allows non-expert users to control complex multi-stage workflows through natural language while the system maintains a coherent and optimized computational pipeline.

The server improves computer technology in several ways. The server uses prompt sentences and generative AI model outputs not only to produce end-user text but also to generate structured task plans and control signals that directly shape hardware-level resource usage and algorithm selection. The server reduces the need for manually defined rule sets and static workflows, which traditionally require expert intervention to modify. Instead, the server leverages the generative model to synthesize intermediate representations that map natural-language intent to machine-executable operations in a normalized operation space. This approach reduces the complexity of the orchestration layer, improves adaptability to novel instructions, and decreases the number of code paths that must be maintained and tested. The server also uses non-standard combinations of rule-based processing and generative model outputs. For example, the server normalizes model outputs to an internal operation code vocabulary, incorporates emotion- and interest-based control parameters into the scheduling algorithm, and combines semantic section detection with syntactic heading detection. These techniques improve summarization accuracy, stability of output structure, and responsiveness to user demands compared to systems that simply pass user text to a model and display the raw response.

The server may implement various alternative embodiments while maintaining the same core technical concept. In one variation, the server executes the generative AI model entirely on-premises using a local hardware accelerator, and uses a training procedure in which the model is fine-tuned on domain-specific documents. The server may optimize the model's attention mechanism by pruning attention heads that contribute little to accuracy, thereby reducing inference time and memory usage. In another variation, the server uses a combination of a smaller, on-device model for quick intent classification and a larger remote model for complex summarization, thus reducing communication load and improving overall latency.

The server may also employ different data structures for storing structured data and results. In one implementation, the server stores document records and summary records in a relational database, with foreign keys linking summaries and table-of-contents entries to original documents. In another implementation, the server uses a document-oriented store where each document is represented by a hierarchical object that includes raw text, structured metadata, summaries, and structural indices. The server may maintain an index of terms derived from the document content and summaries to accelerate search and retrieval operations.

The server may adapt its operation according to the capabilities of the terminal and network conditions. For a terminal with limited display area, the server may generate shorter, more condensed summaries and shallow table-of-contents structures. For a network with limited bandwidth, the server may pre-compress response data and prefer local caches. These adaptations are driven by configuration parameters and by analysis of the communication environment, which are integrated into the task planning and prompt construction stages. In all embodiments, the server uses a generative AI model and prompt sentences not merely to automate a human cognitive task, but to reconfigure and control internal computational processes, including task scheduling, resource allocation, and data structuring. As a result, the system improves the functioning of a computer by reducing manual configuration overhead, increasing processing efficiency and accuracy, and enabling complex, adaptive workflows to be controlled by non-expert users through natural-language interaction.

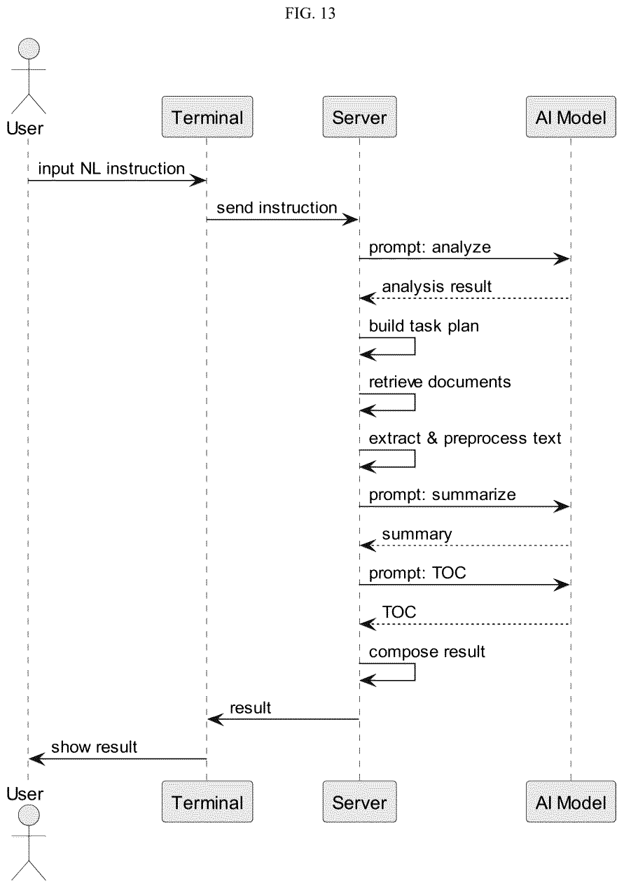

The following describes the processing flow using FIG. 13.

### Step 1:

The user operates the terminal to input a natural-language instruction.

The user types or dictates a sentence such as “Download the latest technology reports and create a summary” into a text input field of a language-based user interface displayed by the terminal.

The terminal receives the instruction text as input, together with implicit context such as the current session identifier and user identifier stored in local memory.

The terminal generates an output data structure that includes the instruction string, the user identifier, the session identifier, and a timestamp, and the terminal transmits this structure to the server over a communication network using a secure protocol.

### Step 2:

The server receives the natural-language instruction and associated metadata from the terminal.

The server takes as input the HTTP request body containing the instruction string, the user identifier, the session identifier, and the timestamp.

The server validates the request, parses the data into internal variables, and stores the instruction and metadata into a persistent storage system as a new interaction record.

The server generates as output a unique task identifier and a normalized instruction record that will be used as the basis for subsequent analysis.

### Step 3:

The server constructs a first prompt sentence for a generative AI model to analyze the instruction.

The server uses as input the normalized instruction record that includes the instruction text and user context.

The server concatenates a system-level text template defining the model's role and required output format with a user-level segment that embeds the instruction, thereby generating a complete prompt sentence such as:
System: “You are a task analyzer. Given a natural-language user instruction, identify the user's intent, the required information sources, and the sequence of operations (e.g., search, download, summarize, structure). Output the result as a structured description with explicit operation codes.”
User: “User instruction: ‘Download the latest technology reports and create a summary.’ Analyze this instruction.”

The server outputs the constructed prompt sentence as a structured message object ready to be sent to the generative AI model.

### Step 4:

The server invokes the generative AI model to generate an analysis result from the prompt sentence.

The server uses as input the prompt message object generated in Step 3 and model configuration parameters such as maximum token length and temperature.

The server tokenizes the prompt sentence, sends the token sequence to the generative AI model, and the model performs attention-based neural computations using its stored weight matrices to predict output tokens representing a structured description of intent, information sources, and processing procedures.

The server decodes the output tokens into text or a structured representation and produces as output an analysis result that includes at least an identified intent, a set of operation codes such as “search_web” or “download_document,” and relevant constraints such as date range and content type.

### Step 5:

The server normalizes the analysis result into an internal task plan.

The server uses as input the raw analysis result text or structure obtained from the generative AI model.

The server applies rule-based parsing and mapping tables to convert free-form descriptions into normalized operation codes, parameter fields, and dependency relations. For example, the server maps “download the latest technology reports” to an operation sequence [“search_web(category=technology, date=latest)”, “download_document(result_set)”]. The server constructs an internal task plan data structure that specifies a sequence of executable steps, required resources, and configuration parameters, and the server outputs this task plan linked to the task identifier.

### Step 6:

The server configures and initiates data retrieval operations based on the task plan.

The server uses as input the task plan that lists data retrieval operations and source identifiers. The server consults configuration tables that map high-level categories such as “technology reports” to specific information sources, access URLs, query parameters, and authentication tokens. Using these mappings, the server constructs HTTP requests or other protocol messages and transmits them via the network interface to external or internal information sources.

The server receives digital data files such as documents as output from these sources, stores the files in nonvolatile storage, and produces retrieval records that link each file to its source, retrieval method, and associated task identifier.

### Step 7:

The server extracts document content and converts it into structured data.

The server uses as input the retrieved digital data files and their retrieval records.

The server selects parsers appropriate to each file type (for example, a PDF parser, an HTML parser, or a document parser), reads the raw binary content, and converts it into plain text and metadata such as title, headings, and author if available. The server also performs text normalization, including character encoding conversion and removal of non-content elements such as headers and footers.

The server outputs structured document objects that contain fields such as document identifier, title, main body text, headings, source information, and language tags, and stores these objects in a database or document store.

### Step 8:

The server preprocesses the structured document data for downstream summarization and indexing.

The server uses as input the structured document objects stored in the database.

The server applies natural language processing operations such as sentence segmentation, paragraph detection, and tokenization, and may compute features such as sentence position scores, keyword frequencies, and estimated topical importance. The server may also detect candidate headings and section boundaries by analyzing text patterns and formatting cues. The server generates enriched document structures that embed these features and segmentation information, and outputs them as preprocessed document representations ready for summarization.

### Step 9:

The server constructs summarization prompt sentences for the generative AI model.

The server uses as input the preprocessed document representations and summarization policies (for example, desired length or detail level) derived from the task plan or user preferences.

The server divides long document text into segments that fit within model token limits and constructs a prompt sentence for each segment, such as:
System: “You are a summarization assistant. Summarize the following technical report segment in clear and concise language. Focus on the main objectives, methods, results, and conclusions. The summary should be approximately 300 words.”
User: “Report segment: [segment text]. Please generate the summary.”

The server outputs one or more summarization prompt sentences associated with document and segment identifiers.

### Step 10:

The server generates summaries by applying the generative AI model to the summarization prompt sentences.

The server uses as input the set of summarization prompt sentences and corresponding document segment identifiers.

The server transmits each prompt to the generative AI model, which encodes the segment text and system instructions using learned embeddings and attention layers, and then decodes an output token sequence that forms a summary text. The server decodes the tokens into human-readable text and associates each summary with the corresponding segment.

The server outputs segment-level summaries and, if necessary, combines them using a deterministic merging algorithm or an additional summarization pass to create a final document-level summary, which is stored as a summary record linked to the original document.

### Step 11:

The server analyzes document structure and generates table-of-contents or index information.

The server uses as input the enriched document representations and, optionally, the document-level summaries.

The server applies pattern-based rules to detect headings and nested sections, and may also construct a prompt sentence such as:

System: “You are a document structuring assistant. Based on the following text, identify logical section titles and their hierarchical relationships. Output a table of contents as a numbered list with main sections and subsections.”

User: “Text: [document or summary text]. Please output the table of contents.”

The server feeds this prompt to the generative AI model, receives descriptive section titles and hierarchy indications, and parses them into a hierarchical data structure representing table-of-contents information or index entries. The server outputs this structural information and stores it in association with each document.

### Step 12:

The server estimates user emotion or degree of interest and adjusts processing parameters.

The server uses as input the current natural-language instruction, previous instructions from the same session, and interaction events such as correction requests or urgency words. The server applies a classification algorithm or a smaller predictive model to map textual and behavioral features to emotion labels or interest scores. Based on these scores, the server adjusts parameters in the task plan, such as the order in which documents are summarized, the length of summaries, the priority of network requests, and the selection between fast approximate processing and slower high-precision processing.

The server outputs updated processing configurations that influence scheduling decisions and resource usage for the ongoing task.

### Step 13:

The server composes result data for presentation and sends it to the terminal.

The server uses as input the document-level summaries, table-of-contents or index structures, source information, and updated task configurations.

The server constructs a response object that includes, for each document, the summary text, structured headings or index entries, and links or identifiers for the original sources. The server may order the results according to the estimated user interest and highlight portions that match inferred priorities. The server formats this data into display-oriented structures such as markup text or structured records suitable for rendering.

The server outputs the formatted result data and transmits it to the terminal over the communication network as a response to the user's request.

### Step 14:

The terminal presents the received result data to the user and supports further interaction. The terminal uses as input the response data received from the server, including summaries, headings, and source references.

The terminal parses the data and renders a dialog-style interface displaying the original instruction, system status messages, and the generated summaries with clickable table-of-contents entries. The terminal may allow the user to expand or collapse sections, navigate directly to specific document portions, or issue new instructions via the same interface. The terminal outputs an updated user interface state on the display, enabling the user to inspect the results and, if needed, provide additional natural-language instructions that will initiate another iteration of the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer systems that accept natural-language instructions from users often treat such instructions as simple text queries and perform fixed, pre-programmed operations. These systems typically rely on rigid rule-based parsers or narrowly trained intent classifiers that are unable to robustly decompose complex, multi-step user requests into executable tasks. As a result, when a user issues a compound instruction such as downloading specific electronic records, organizing those records in a hierarchical storage structure, and generating a summary or table-of-contents, the system either fails to understand the full intent or requires extensive manual configuration by an expert operator. This leads to increased latency, user frustration, and a high maintenance burden for developers who must continuously update parsing rules and workflows.

Additionally, existing systems generally lack a mechanism to incorporate the user's emotional state into the core control logic of task execution. While some applications may perform sentiment analysis for reporting or user profiling, such emotional information is rarely used as an input signal to a task scheduler or execution engine. Consequently, conventional architectures cannot dynamically adjust a task priority, task ordering, or presentation format of results based on whether a user is, for example, stressed, confused, or relaxed. This omission results in a static interaction model in which all tasks are treated equally regardless of their impact on user cognitive load, thereby failing to optimize responsiveness and usability for non-expert users.

Further, in many known systems, any integration of large-scale generative AI models is limited to directly generating natural-language responses. These systems typically do not systematically employ a generative AI model as an intermediate reasoning component for producing machine-oriented, structured task plans via prompt sentences, nor do they use such models to automatically extend the set of supported task types or processing procedures at runtime. Hence, the computational pipeline remains rigid: when new task types or workflows are required, software engineers must redesign and deploy new code, resulting in slow adaptation and reduced scalability.

Moreover, file organization and content-structuring operations, such as automatically placing electronic documents into appropriate storage locations and generating table-of-contents information from document structure, are often implemented as isolated batch utilities that do not integrate with real-time natural-language interfaces or emotion-aware control. In such architectures, the system cannot convert a user's high-level natural-language instruction into a coordinated sequence of document retrieval, file operations, and content analysis tasks that run under a unified scheduling policy.

Therefore, there is a need for improved computer technology that (i) tightly integrates a generative AI model into the instruction-interpretation and task-planning pipeline using prompt sentences, (ii) computes and uses user emotion as a first-class control parameter for dynamic task scheduling and result presentation, and (iii) automatically performs data acquisition, organization, and content structuring in response to complex, natural-language user instructions, all while remaining operable by users without specialized technical knowledge. Such improvements should enhance the efficiency, flexibility, and responsiveness of the overall information-processing system, and reduce the burden on developers to manually encode and maintain complex workflows.

The specific processing by the specific processing unit 290 of the data processing device 12 in Application Example 2 is realized by the following means.

The present invention provides a server comprising a processor configured to receive user instructions expressed in natural language, to input prompt sentences to a generative AI model in order to obtain structured analysis data describing task content and task conditions, to identify a plurality of executable tasks including at least information-acquisition tasks and device-control tasks based on the structured analysis data, to compute a user emotional state from voice, image, or text information and generate control parameters that adjust a priority, an execution order, and a presentation format of the plurality of tasks according to the user emotional state, to acquire digital information from storage or communication resources and organize the digital information into structured information including at least table-of-contents information or recommendation information, and to generate and transmit response information to a terminal based on the structured information and the user emotional state. This enables the computer system to internally transform complex natural-language instructions into machine-executable task plans using the generative AI model, to dynamically schedule and adapt those tasks in accordance with real-time emotional feedback from the user, and to automatically perform data retrieval, file organization, and content structuring in a manner that improves task throughput, interaction efficiency, and usability for non-expert users while reducing the need for manually coded rule sets and static workflows.

The term “user instruction” refers to a request, command, or query expressed by a user in natural language and input to the system via an input device or user interface.

The term “natural language” refers to a human language, such as spoken or written language, that is not constrained to a formal programming or query syntax and that is processed by the system using natural-language processing techniques.

The term “prompt sentence” refers to a text string supplied to a generative AI model to specify a context, an intent, a constraint, or a desired output format for the model's processing.

The term “generative AI model” refers to a computational model that generates text or other data in response to an input prompt sentence, and that is configured to perform at least one of interpretation, reasoning, planning, and content generation.

The term “structured data” refers to data organized according to a predefined format or schema, such as a key-value set, a record, or a hierarchical object, that can be directly processed by computer programs.

The term “analysis result data” refers to structured data representing an interpretation of a user instruction, including at least a task content, a task condition, and related parameters extracted by natural-language analysis.

The term “task content” refers to a description of an operation to be executed by the system, such as information acquisition, data organization, content generation, or device control.

The term “task condition” refers to a constraint or parameter associated with a task content, including at least a target object, a time range, a sorting key, a location, or a filtering criterion.

The term “information resource” refers to any storage or service that provides digital information, including at least local storage systems, remote storage systems, and network-accessible information services.

The term “device resource” refers to any controllable hardware component or external apparatus, including at least processing devices, storage devices, and operational equipment such as robots or automated machines.

The term “acquisition process” refers to a sequence of computer operations for obtaining digital information from at least one information resource via a communication interface or storage access.

The term “control process” refers to a sequence of computer operations for generating and transmitting control signals to a device resource in order to cause the device resource to execute a physical or logical operation.

The term “execution procedure” refers to an ordered set of actions and processing steps that define how a particular task is to be carried out by the system.

The term “additional prompt sentence” refers to a prompt sentence that is generated after an initial analysis in order to refine, supplement, or extend a task content or an execution procedure using a generative AI model.

The term “voice information” refers to data representing sound produced by a user, including at least audio waveforms, digitized speech, and extracted acoustic features.

The term “image information” refers to data representing visual information associated with a user, including at least still images, video frames, and extracted visual features such as facial landmarks.

The term “character information” refers to text data derived from user input, including at least transcribed speech, typed text, and converted symbolic data.

The term “emotional state” refers to a classification or score representing a psychological or affective condition of a user, including at least joy, anger, sadness, stress, confusion, and neutrality.

The term “control parameter” refers to a variable or set of variables computed by the system from the emotional state and configured to influence at least one of task priority, execution order, and presentation format.

The term “priority” refers to a relative importance level assigned to a task for scheduling or resource allocation purposes within the system.

The term “execution method” refers to a mode or style in which a task is carried out, including at least a degree of detail, a level of automation, a timing, and a selection of sub-operations.

The term “execution order” refers to a sequence arrangement specifying in which temporal order multiple tasks are processed by the system.

The term “presentation format” refers to a layout or style used to output information to a user interface, including at least text length, level of detail, visual arrangement, and emphasis. The term “digital information” refers to information represented in an electronic form, including at least documents, records, media files, metadata, and structured datasets.

The term “information storage apparatus” refers to a hardware or virtual component configured to store digital information, including at least file systems, databases, and cloud storage systems.

The term “communication apparatus” refers to a hardware or software component configured to transmit or receive digital information via a communication network.

The term “classification information” refers to metadata or criteria that indicate one or more categories, labels, or groups to which a piece of digital information belongs.

The term “hierarchy information” refers to metadata or structural data indicating a parent-child or level relationship among pieces of digital information, such as folder structures or document heading levels.

The term “structured information” refers to organized information generated by the system from digital information, including at least table-of-contents information and recommendation information.

The term “table-of-contents information” refers to structured information that lists sections, subsections, or other units of content in an ordered manner, optionally including hierarchical relationships and position indicators.

The term “recommendation information” refers to structured information indicating one or more suggested items or actions for a user, selected based on at least user instructions, digital information, and an emotional state.

The term “response information” refers to information generated by the processor for delivery to a terminal, including at least structured information, explanatory text, status information, and control instructions.

The term “user interface apparatus” refers to a component configured to present information to a user and to accept input from the user, including at least display devices, input devices, and interactive software components.

The term “terminal apparatus” refers to an end-user device that communicates with the server, including at least portable devices, stationary computing devices, and head-mounted display devices.

The term “electronic document” refers to a digital file containing human-readable content, including at least text documents, presentation files, and formatted records.

The term “recorded data” refers to digital data captured or logged by a device or application, including at least log data, measurement data, and multimedia recordings.

The term “external information source” refers to any information resource located outside the server's local storage, including at least remote servers, web services, and networked databases.

The term “communication network” refers to a wired or wireless infrastructure that enables data exchange between the server, the terminal apparatus, and external information sources. The term “storage area” refers to a logical or physical region within an information storage apparatus designated for storing one or more digital files.

The term “file operation process” refers to a sequence of operations for managing files, including at least creating, moving, copying, renaming, or deleting files in a storage area. The term “structural information” refers to data indicating an internal organization of content within an electronic document or recorded data, including at least heading markers, section boundaries, and index information.

The term “interactive interface” refers to a user interface that supports bidirectional communication between a user and the system, allowing users to iteratively issue instructions and receive responses.

The term “task type” refers to a classification of a task according to its general function, including at least information retrieval, data organization, content generation, and device control.

The term “processing procedure” refers to a defined sequence of operations or a workflow for executing a task type within the system.

The term “specialized knowledge” refers to technical expertise or domain-specific understanding beyond the capabilities of a typical end user.

The term “task content expansion” refers to a modification of system behavior in which new task types, processing procedures, or combinations of tasks become executable without requiring manual programming by a developer.

In one embodiment, a server implements the claimed invention as a network-accessible information processing apparatus. The server includes at least one hardware processor, a main memory, a non-volatile storage device, and a network interface. The server executes an operating system and multiple software modules, including a natural-language processing module, a generative AI interface module, an emotion estimation module, a task planning and scheduling module, a data acquisition and organization module, and a user interface integration module. A terminal comprises an input/output device, such as a portable computing device, a stationary computing device, or a head-mounted display device, and communicates with the server through a communication network. A user operates the terminal and issues natural-language instructions, which are processed by the server as described below.

In one embodiment, the server executes a natural-language processing program implemented using a high-level programming language and a natural-language processing library, such as a tokenization and part-of-speech tagging library or a dependency parsing library. The server receives a user instruction expressed in natural language as text data from the terminal. When the user speaks into a microphone, the terminal uses a speech recognition service to convert audio signals into text; the terminal then transmits the text to the server. The server stores the received text in a memory buffer and performs lexical analysis and syntactic parsing to identify candidate tasks, objects, and conditions. The server transforms the parsed result into an intermediate representation, such as a list of tokens with part-of-speech tags, dependency relations, and candidate named entities.

In one embodiment, the server uses a generative AI model to refine and structure this intermediate representation. The generative AI model is implemented as a neural-network-based language model deployed on a separate computation node or as a service accessible through an application programming interface. The generative AI model has a multi-layer transformer architecture that includes an embedding layer, a plurality of self-attention layers with multi-head attention mechanisms, feed-forward sublayers, and layer normalization components. The model is pre-trained on a large corpus of text data using an auto-regressive language modeling objective that minimizes a cross-entropy loss between predicted token distributions and ground-truth tokens. During training, the model updates weight parameters using gradient-based optimization, such as stochastic gradient descent with adaptive moment estimation, and may employ regularization techniques such as dropout and layer-wise learning-rate schedules. Fine-tuning may be performed on a dataset consisting of annotated user instructions and corresponding structured task specifications.

In this configuration, the server generates a prompt sentence that describes the user instruction, a target output schema, and any relevant constraints. The server concatenates the prompt sentence with the original user instruction and sends the combined text to the generative AI model. The generative AI model outputs a structured representation, for example a textual expression that can be deterministically parsed into a key-value structure specifying a task content (such as “download document”, “organize folder”, “generate table of contents”, “control device”) and task conditions (such as target URLs, folder names, time ranges, or sort keys). The server parses the output of the generative AI model using a deterministic parser and stores the resulting structured data in a task descriptor data structure in memory.

The server thereby avoids relying solely on hand-written rules or fixed intent-classification models. Instead, the server uses the generative AI model as a flexible, learned transformation component that maps natural-language instructions to machine-oriented representations. Because the server constrains the generative AI model output to a specific schema using prompt sentences, the server can deterministically convert the output into internal data structures without manual intervention. This leads to improved robustness and flexibility compared to conventional rule-based parsers, and reduces the need to redeploy code when new task types are added.

In one embodiment, the server computes an emotional state of the user based on voice information, image information, or character information. The terminal captures audio and video of the user, and transmits them to the server as encoded streams. The server extracts acoustic features such as fundamental frequency, spectral envelope, energy, and prosody statistics, and visual features such as facial keypoints, facial action units, and head pose angles. The server may also encode the user's text into a sequence of token embeddings. An emotion estimation model implemented as a neural network processes these features. The emotion estimation model may have a multi-branch architecture in which audio features, visual features, and textual features are first encoded by respective subnetworks, such as convolutional or recurrent layers for audio, convolutional layers for images, and transformer layers for text; the encoded features are then concatenated and fed into fully connected layers that output scores for multiple emotion classes.

During training of the emotion estimation model, the server uses labeled datasets of multimodal signals and associated emotion labels. The server defines a loss function that combines cross-entropy loss for categorical emotion labels with auxiliary losses such as mean-squared error for continuous arousal or valence dimensions. The server updates the network weights using backpropagation and gradient descent. At run time, the server applies the trained model to incoming feature vectors and obtains a probability distribution over emotion classes. The server selects the highest-probability emotion or computes a weighted combination of emotions and stores this as the user's emotional state for the current session. In one embodiment, the server uses the emotional state to compute control parameters that influence task scheduling and presentation format. The task planning and scheduling module maintains a queue of task descriptors generated from the structured data obtained from the generative AI model. Each task descriptor includes a base priority, an estimated cost, and a sensitivity score indicating how strongly the user experience depends on timely execution of the task. The server calculates a priority adjustment factor based on the emotional state, such as increasing the priority of tasks that reduce cognitive load when the user is stressed, or elevating tasks that provide engaging or entertaining content when the user is joyful. The server modifies the priority of each task by applying a function of the base priority, the emotional state, and the sensitivity score. This function may be a non-linear mapping that increases the difference between high-priority and low-priority tasks under high stress conditions to reduce perceived latency for critical functions. The server then selects tasks from the queue according to the adjusted priorities.

By integrating emotional state into the priority calculation, the server changes the internal behavior of the task scheduler, improving perceived responsiveness and reducing unnecessary processing for tasks that are less relevant under the current emotional context. This yields a technical effect of reducing the average time-to-response for emotionally critical tasks without increasing total computational load, and thereby optimizes resource allocation at the server level.

In one embodiment, the server executes a data acquisition and organization program that retrieves digital information from information storage apparatuses and communication apparatuses. When the structured task descriptor indicates that an electronic document should be downloaded, the server creates a download job with a specified network location and a target storage area. The server uses a network client library to send a request through a communication network and receives the response data as a stream, which the server writes to non-volatile storage. The server validates the integrity of the file via checksum or content-length verification. The server then associates metadata with the file, including a timestamp, the source identifier, and any tags inferred from the user instruction or from the content. In one embodiment, the server organizes the digital information in a hierarchical folder structure. The server maintains a directory tree in the storage device, with nodes representing folders and leaves representing files. When a task indicates a folder name, the server traverses the directory tree to locate or create the corresponding node. The server moves or copies files into the designated folder using file system operations. The server may apply a naming convention, such as including the date and a normalized version of the document title, to reduce ambiguity and facilitate retrieval. The server stores the folder path and file identifiers in an index maintained in a database.

In one embodiment, the server generates table-of-contents information from electronic documents. The server selects documents for analysis based on the folder and metadata. The server opens each document using a format-specific library; for example, the server reads a document file and parses its structure to identify heading elements. The server extracts headings based on style tags, font sizes, or explicit structural markers. The server assigns each heading a level according to a rule set that maps style attributes or markers to hierarchy levels. The server then constructs a tree data structure representing the document hierarchy. The server serializes this tree into a table-of-contents list, such as a list of entries with text, level, and position offsets, and stores the result as structured information associated with the folder or file.

This specific organization of digital information into structured table-of-contents information improves retrieval performance and user navigation. When the user later requests a summary or a specific section, the server can directly access the relevant portion using the precomputed structural information instead of scanning the entire document. This reduces processing time and lowers the I/O overhead on the storage device, contributing to improved computational efficiency.

In one embodiment, the server provides recommendation information based on user instructions, structured data, and emotional state. The server maintains a repository of candidate items, such as media content entries or document references, with associated metadata including category labels, ratings, and prior usage statistics. The server constructs feature vectors for each candidate item, incorporating both static attributes and dynamic attributes such as recent access frequency. The server also constructs a context vector representing the user's current intent and emotional state. The server computes a relevance score for each candidate item using a scoring function, which may be a learned function implemented as a neural network or a parametric scoring model. The server ranks items according to the relevance scores and selects the top-ranked items as recommendation information. By incorporating emotional state into the scoring function, the server adapts content selection to reduce stress or increase engagement.

In one embodiment, the server uses a generative AI model not only for interpreting instructions but also for refining task plans and generating explanation messages. The server constructs specific prompt sentences that encode internal data, such as “Analyze the following instruction and output a structured description of tasks and parameters: [user instruction text].” or “Given that the user is stressed and has requested: ‘Prepare next week's presentation materials’, propose a minimal set of steps to complete the core work while reducing the user's cognitive load.” The server sends these prompt sentences to the generative AI model and receives natural-language descriptions or structured plans. The server can then translate the generated plans into concrete operations. Because the server defines clear input-output formats and uses internal validation of the generative AI model's output, the system performs a transformation from natural language to executable task graphs that is more flexible and general than conventional procedural pipelines.

In another embodiment, the server controls device resources such as industrial machines or robotic apparatuses. The structured task descriptor may contain a device operation type and a device identifier. The server loads a device control module that translates high-level operations into low-level control signals. The server maps each task to a sequence of device commands, applies safety checks based on device status, and transmits commands through a fieldbus or network protocol supported by the device. This configuration allows the server to perform closed-loop control, where responses from the device are monitored and may affect subsequent task scheduling or adjustment. For example, if the device reports a fault, the server reduces the priority of additional device tasks and elevates diagnostic procedures.

By executing such device control logic in combination with natural-language and emotion-aware task planning, the system moves beyond simple information retrieval and into concrete physical control. The server thus improves the integration between user-level intentions and machine-level operations, achieving technical effects such as shorter configuration time for industrial tasks, reduction in operator errors, and improved throughput due to adaptive scheduling based on user state and device status.

In one embodiment, the server and terminal cooperate to provide an interactive interface for non-expert users. The terminal presents a dialogue interface in which the user can issue instructions in natural language and receive feedback. The server generates response information that includes structured results and explanatory text. The server may use prompt sentences such as “The user is searching for action movies. Generate a user-friendly explanation of the top 5 movies sorted by rating, including a one-sentence summary for each movie.” or “A customer looks anxious and asks if a product is available. Suggest a short, reassuring explanation that emphasizes ease of use and reliability.” The generative AI model produces human-readable messages that the server includes in the response information. The terminal displays these messages, and the user can follow suggested actions or refine the request.

From a technical standpoint, the architecture improves computer operation by offloading complex interpretation and planning tasks to a generative AI model, while constraining the model using prompt sentences and structured schemas to produce deterministic, machine-usable outputs. The emotion-aware scheduling mechanism directly influences internal resource management by changing task ordering and response generation policies based on user state. The use of precomputed structures like document hierarchies and organized folder indexes reduces repeated computation and I/O overhead. Furthermore, by using structured data representations for tasks and emotional states, the server can apply algorithmic optimization methods—for example, priority queues and scheduling heuristics—to achieve lower latency and better utilization of processing and network resources.

In alternative embodiments, the server may employ different natural-language processing libraries, different generative AI models with varying neural-network configurations, or different emotion estimation models. The number of layers, attention heads, and hidden dimensions in the generative AI model may be selected according to computing capacity and latency requirements. The emotion estimation model may be trained using different feature sets or loss functions, and may be updated periodically with new training data. The server may store structured data and task descriptors in different database systems, such as relational databases or key-value stores. The terminal may be implemented as a mobile computing device, a desktop computing device, or a wearable device. In each case, the server, terminal, and user cooperate to implement the claimed system: the server analyzes natural-language user instructions via prompt sentences to a generative AI model, structures tasks and task conditions, estimates emotional state, computes control parameters that affect task priority and execution, organizes digital information into structured forms, and provides response information to the terminal in a manner that improves technical performance and usability beyond simple automation of human workflows.

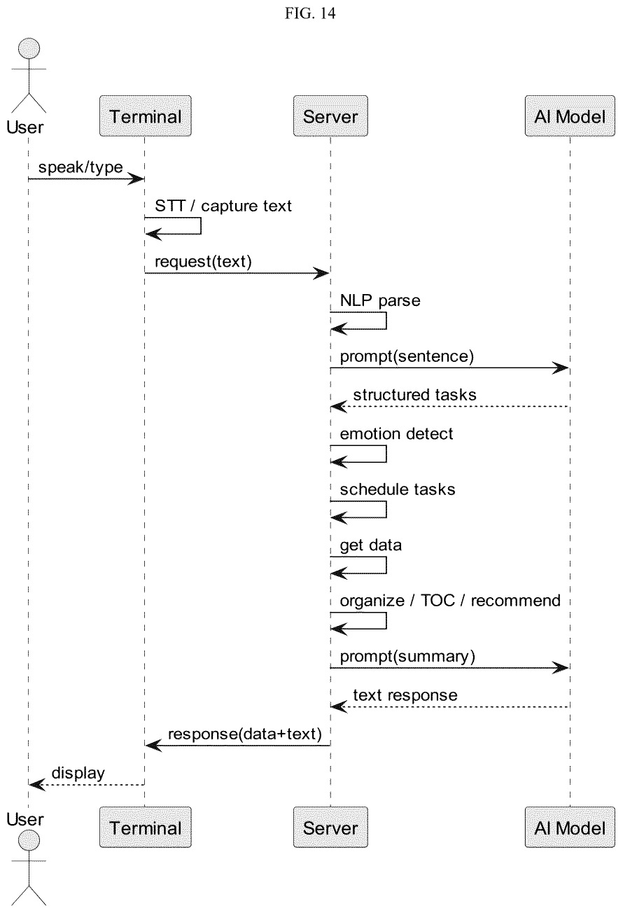

The following describes the processing flow using FIG. 14.

### Step 1:

The user provides an instruction in natural language.

The user speaks into a microphone of the terminal or types text into an input field.

The input in this step is unstructured natural-language content (speech waveform or typed text).

The user specifies a requested operation, such as “Download the document from http://example.com/document.pdf and create a table of contents,” or “Find action movies and list them by highest rating.”

The output of this step is raw user input captured by the terminal as either audio data or character data.

### Step 2:

The terminal converts the raw input into text and sends it to the server.

The terminal applies a speech recognition process when the input is audio.

The input of this step is audio data from the microphone or typed text from a keyboard or touch interface.

The terminal performs data processing by invoking a speech-to-text engine to transform audio into a text string, and by adding metadata such as timestamp and user identifier.

The terminal constructs a request message containing the text of the instruction and sends this message through a communication network to the server.

The output of this step is a network message that includes the user's instruction as text data and associated metadata.

### Step 3:

The server receives the text instruction and performs initial natural-language analysis.

The input of this step is the request message containing the natural-language instruction text. The server performs data processing by tokenizing the text into words or subwords, assigning part-of-speech tags, and computing syntactic dependencies to obtain an intermediate linguistic representation.

The server extracts candidate elements such as verbs, objects, and modifiers and stores them in an intermediate data structure (for example, a list of tokens with annotations).

The output of this step is an intermediate representation of the instruction that captures lexical and syntactic features but is not yet structured as executable tasks.

### Step 4:

The server constructs a prompt sentence and sends it to a generative AI model for structured interpretation.

The input of this step is the intermediate linguistic representation and the original instruction text.

The server generates a prompt sentence that describes the task of converting the instruction into a structured form, for example: “Analyze the following instruction and output a structured description of tasks and parameters: [user instruction].”

The server concatenates the prompt sentence and the instruction and sends the combined text to the generative AI model.

The generative AI model produces an output text that encodes a structured interpretation, such as a list of task types and parameters in a constrained textual format.

The server parses the generative AI model's output deterministically to transform it into structured data (for example, a task descriptor containing fields for task content and task conditions).

The output of this step is a structured task descriptor that specifies one or more tasks and associated parameters in a machine-readable format.

### Step 5:

The server computes the user's emotional state from multimodal input.

The input of this step is user-related data, including at least one of audio signals, video frames, and text content, received from the terminal.

The server performs data processing by extracting numerical features, such as acoustic features from audio, facial features from images, and semantic features from text, and then feeding these feature vectors into an emotion estimation model.

The server executes neural-network computations inside the emotion estimation model to calculate probability scores for multiple emotion classes, such as joy, anger, sadness, and stress.

The server selects a dominant emotion or computes a weighted combination of emotions and records the result as the user's current emotional state.

The output of this step is an emotion descriptor that includes at least one emotion label and associated scores.

### Step 6:

The server determines task priorities and scheduling parameters using the structured tasks and the emotional state.

The input of this step is the structured task descriptor from the generative AI model and the emotion descriptor from the emotion estimation model.

The server performs data processing by computing a control parameter for each task; this control parameter is derived from the base priority of the task, its estimated execution cost, and the user's emotional state.

The server applies a scheduling algorithm that adjusts task precedence; for example, the server increases priority for tasks that quickly satisfy a stressed user's needs and delays non-critical background tasks.

The server updates an internal task queue or scheduler data structure, sorting tasks according to the adjusted priorities.

The output of this step is an ordered set of tasks with associated scheduling information that dictates the execution order and, optionally, the execution method.

### Step 7:

The server acquires digital information from storage or network resources according to the scheduled tasks.

The input of this step is the ordered set of tasks in which some tasks require information acquisition, such as document download or database search.

The server performs data processing by, for example, generating network requests to external information sources, executing database queries against local or remote databases, and reading or writing files in storage devices.

When the task is to download a document, the server sends an HTTP request to the specified resource, receives the response stream, verifies integrity, and stores the received data in a designated storage area.

When the task is to retrieve records (such as movie entries), the server executes a structured query, processes the result set, and converts the records into internal data objects.

The output of this step is acquired digital information stored in server-managed storage and referenced by identifiers in the task descriptors.

### Step 8:

The server organizes the acquired digital information and generates structured information such as table-of-contents data or recommendation lists.

The input of this step is the digital information retrieved or downloaded in Step 7 and the corresponding organizational instructions from the task descriptors.

The server performs data processing by classifying the digital information according to metadata or instruction-based rules, mapping each item to a folder or category, and updating a directory tree or index.

For document-structuring tasks, the server reads the content of each document, extracts headings and section boundaries, and builds a hierarchical representation of the document structure.

The server converts this hierarchical representation into table-of-contents information, such as an ordered list of entries with level information and positions.

For recommendation tasks, the server computes relevance scores using item features, user intent, and emotional state and ranks candidate items accordingly.

The output of this step is structured information, including table-of-contents lists, organized folder mappings, and ranked recommendation sets.

### Step 9:

The server generates response information to be provided to the user via the terminal.

The input of this step is the structured information generated in Step 8, the scheduling information from Step 6, and the emotion descriptor from Step 5.

The server performs data processing by selecting which information to present first, how much detail to include, and in what format, according to the task priorities and emotional state.

The server may construct explanatory messages or summaries by creating a prompt sentence such as “The user is stressed and requested a summary of today's documents. Generate a concise explanation of the key points,” and sending this prompt sentence to the generative AI model.

The generative AI model returns a natural-language message, which the server integrates with structured data into a response payload.

The output of this step is response information that includes structured results (such as tables of contents or lists) and textual explanations, formatted for transmission to the terminal.

### Step 10:

The terminal receives the response information and presents it to the user.

The input of this step is the response payload transmitted by the server, containing structured data and textual content.

The terminal performs data processing by parsing the response, mapping data fields to user interface components, and generating display elements such as lists, headings, and messages. The terminal selects a suitable presentation mode, for example a scrollable list on a handheld display or an overlay in a head-mounted display, and formats the content to match display capabilities and user preferences.

The terminal renders the content on its output device so that the user can view search results, document structures, recommendations, or device status reports.

The output of this step is a graphical or textual presentation on the terminal interface, enabling the user to understand the system's actions and results.

### Step 11:

The user reviews the presented information and issues follow-up instructions if necessary. The input of this step is the information displayed on the terminal, such as a table of contents, a ranked list of movies, or a summary of downloaded documents.

The user evaluates whether the presented results satisfy the original intent or whether additional operations, such as filtering, refining, or initiating new tasks, are required.

The user may speak or type a new natural-language instruction, such as “Summarize each chapter in two sentences,” “Filter the movies to those released after 2020,” or “Start the next batch of device operations.”

The output of this step is a new raw instruction captured by the terminal, which becomes the input of Step 1 in the next processing cycle.

### Step 12:

The server updates internal logs and learning-related data structures based on executed tasks and user interactions.

The input of this step is task execution results, including success or failure codes, elapsed time, resource usage statistics, and user feedback inferred from subsequent instructions or explicit evaluations.

The server performs data processing by recording this information in log repositories and, optionally, generating aggregated statistics such as average response time by task type, success rates, and patterns of emotional state transitions.

The server may use this data to refine scheduling heuristics, adjust default priorities, or retrain components such as the emotion estimation model or auxiliary ranking models, thereby optimizing future processing.

The output of this step is updated performance and behavior profiles stored in server-side databases, which influence subsequent executions and improve the technical performance of the system over time.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

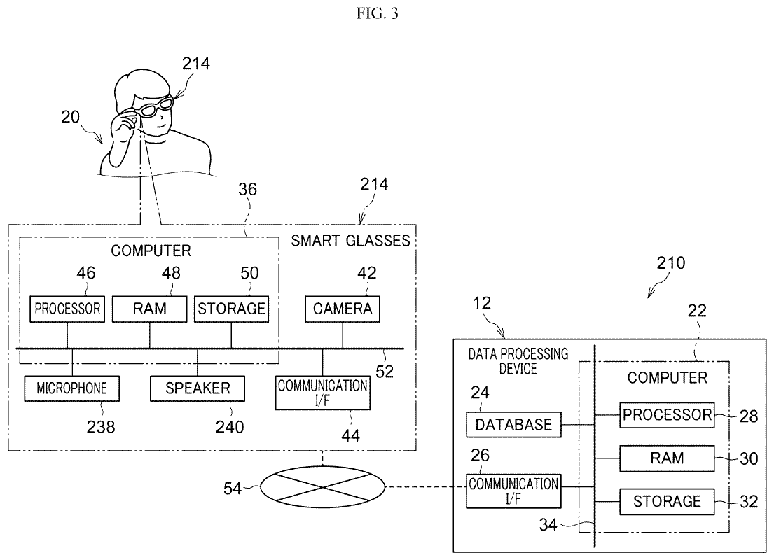

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

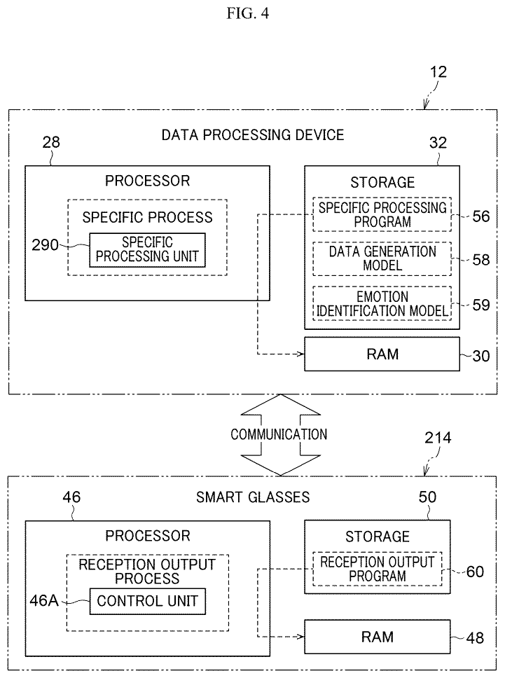

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

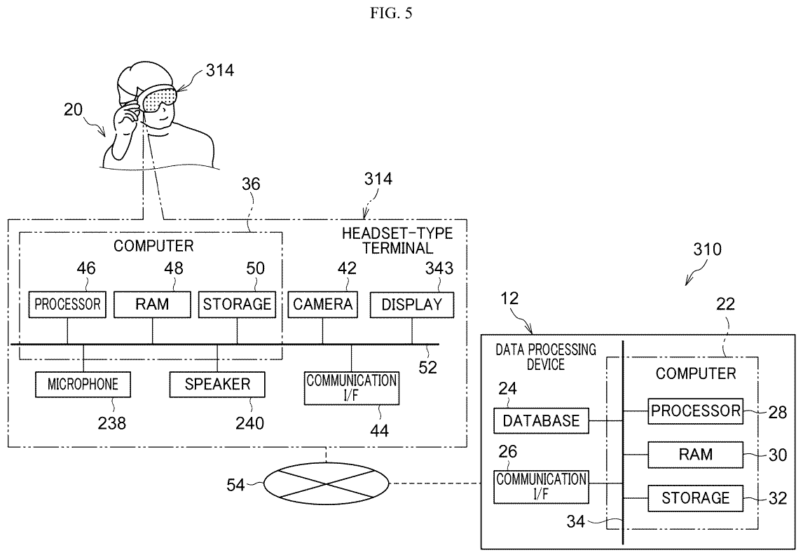

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

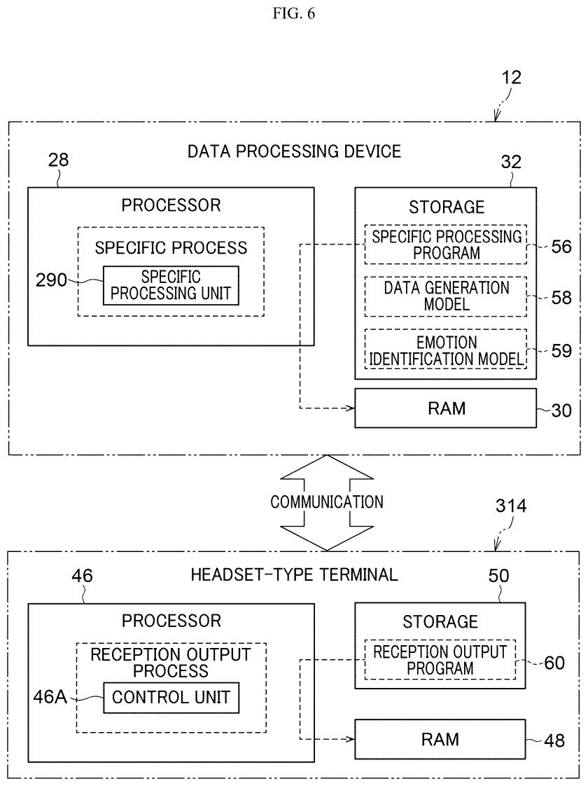

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

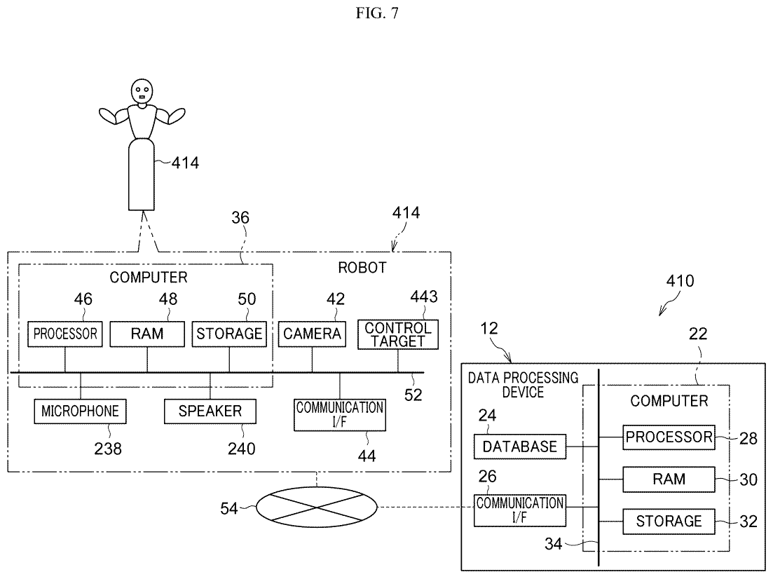

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

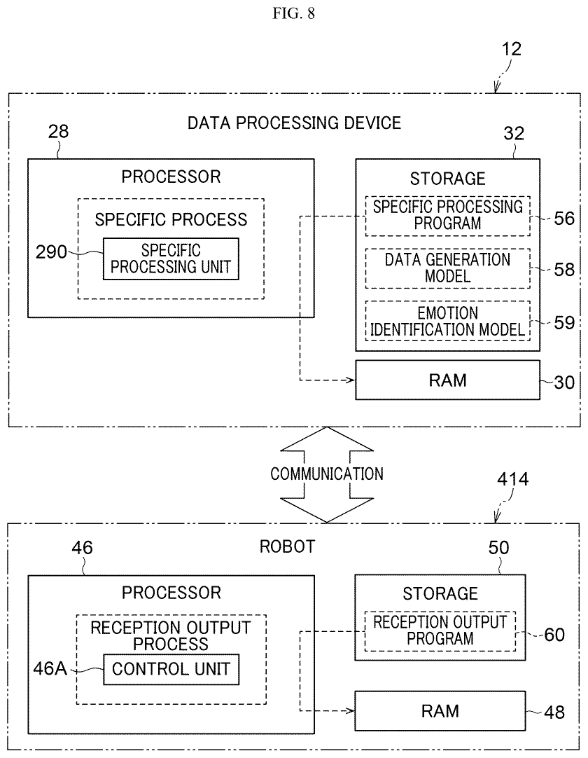

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

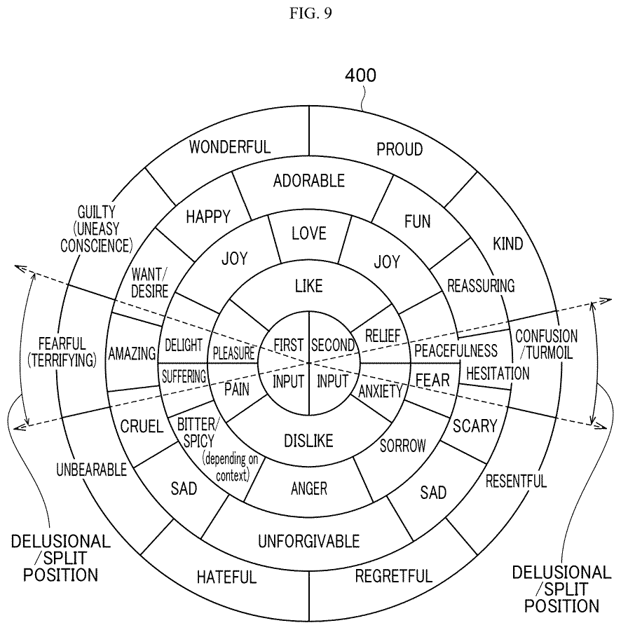

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

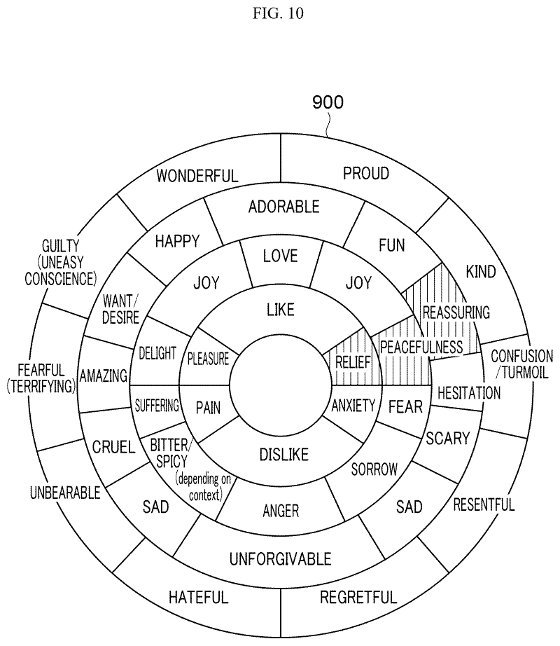

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive a user instruction expressed in natural language from a user terminal and generate a prompt sentence for a generative AI model to analyze the user instruction, input the prompt sentence into the generative AI model, and obtain structured task information representing a content of the user instruction,
search, based on acquisition conditions included in the structured task information, digital data stored in an information storage device connected via a network, and acquire metadata and content data of the digital data by using an application program interface,
aggregate the acquired digital data into a predetermined storage area by using a file system function or a folder management function of an external storage service, and organize the digital data within the storage area in accordance with classification conditions included in the structured task information,
extract title information and at least part of content from each piece of digital data in the storage area, generate a prompt sentence for the generative AI model based on input data including the extraction result, input the prompt sentence into the generative AI model to generate table-of-contents data in a markup format, and record the table-of-contents data in the storage area as a table-of-contents file,
generate, based on notification conditions included in the structured task information, a notification message including the table-of-contents file and location information of the storage area, and transmit the notification message to the user terminal in accordance with a communication protocol,
estimate an emotional state of a user based on an expression included in the user instruction and usage information acquired from the user terminal, and dynamically adjust at least one of an acquisition order of the digital data, an organization method of the digital data, and a content of generation of the table-of-contents data in accordance with the emotional state, and provide an operation screen that allows a user without specialized knowledge to input the user instruction in natural language, and implement a user interface that automatically performs generation of the prompt sentence for the generative AI model and extension of processing procedures based on the structured task information.

### Supplementary 2

The system according to supplementary 1,
wherein the processor is configured to
target, as the digital data, document data acquired by a user during a predetermined period, selectively acquire, via the application program interface, document data corresponding to a predetermined file type, aggregate the document data into a single folder by using the file system function, and cause the generative AI model to automatically generate a table of contents corresponding to the document data in the folder by providing the generative AI model with input data including the title information and at least part of the content of the document data.

### Supplementary 3

The system according to supplementary 1,
wherein the processor is configured to
automatically generate, each time the user inputs the user instruction in natural language via the user interface, the prompt sentence for the generative AI model, determine a new processing procedure or a modification of an existing processing procedure based on the structured task information, and register the processing procedure as an executable task sequence, thereby enabling expansion and modification of work content without requiring additional settings by the user.

### Application Example 1

### Supplementary 1

A system comprising a processor,
wherein the processor is configured to
receive a user instruction expressed in natural language via a language-based user interface and acquire the instruction as text information,
identify, based on the text information, a type of target object or information resource and a processing content, and control an information collection process including acquiring visual information of a physical object by using an imaging device or a code reading device, and acquiring digital data of an information resource via a communication network,
perform an identification process on the visual information to generate structured object information including an object identifier, classify the acquired digital data based on classification information, and integrate the structured object information and the classified digital data as a data set,
execute database processing on the data set including the object information, the database processing including updating attribute information, calculating inventory quantities, assigning classification labels, and extracting newly received objects, to update an inventory state or an information state,
generate a prompt sentence as an input for a generative AI model based on the updated data set, call the generative AI model as a generation engine operating on an external information processing apparatus, and provide the prompt sentence and the data set as inputs to the generative AI model so as to cause the generative AI model to generate organized text information including a table-of-contents structure,
extract heading information and item information from the generated text information, convert the heading information and the item information into menu information hierarchically displayable on a display device, and transmit the menu information to a terminal device so that the terminal device presents a table of contents and a corresponding item list on a display area, and
estimate an emotional state of the user based on speech audio of the user or biometric information, and, in accordance with the emotional state, modify at least one of the information collection process, the database processing, and contents of the prompt sentence for the generative AI model, so as to dynamically adjust a priority or an execution method of a task.

### Supplementary 2

The system according to supplementary 1,
wherein the processor is configured to
execute the information collection process by performing an inquiry process to an information management apparatus that stores the object information, acquire, as response information, at least a product name, price information, inventory quantity information, classification information, and arrival date information, extract, by the database processing, a group of newly received objects based on the arrival date information and the inventory quantity information, and generate the prompt sentence so as to request the generative AI model to generate a list and a table of contents in which the group of newly received objects is organized by attribute.

### Supplementary 3

The system according to supplementary 1,
wherein the processor is configured to
provide the language-based user interface as an input screen or a voice input function operable without specialized operational knowledge, automatically regenerate the prompt sentence in response to processing conditions or display conditions re-input by the user in natural language, and update, in linkage, a query content to the generative AI model and extraction conditions of the database processing so as to enable stepwise expansion of a work range relating to inventory management or information organization.

### Example 2

### Supplementary 1

A system comprising a processor,
wherein the processor is configured to
receive, from a terminal, an instruction expressed in a natural language by a user and acquire the instruction and associated attribute information as data,
construct, using the acquired instruction as input information, a prompt sentence that defines a role and an output format for a generative AI model, input the prompt sentence and the instruction into the generative AI model, and obtain, from the generative AI model, a structured analysis result including an intent of the instruction, required information sources, and processing procedures,
search for and acquire digital data from an external information source via a communication network or from an internal information storage device, based on the analysis result,
extract document content from the acquired digital data, perform preprocessing on the document content, and store the preprocessed content as structured data,
generate, using the structured data as input information, a prompt sentence that defines a summarization policy and an output format, and execute summarization processing using the generative AI model or another information processing algorithm to generate a summarization result,
analyze a logical structure of a document based on the structured data and/or the summarization result, and generate table-of-contents information or index information including hierarchical heading information,
create result data in which the summarization result, the table-of-contents information, and source information of the acquired digital data are associated with each other, and transmit the result data to the terminal as display data,
identify an emotion or a degree of interest of the user based on the natural-language instruction or a user interaction history, and dynamically adjust at least one of an order of information acquisition, a level of detail of the summarization, a presentation format, and a processing schedule in accordance with an identification result, and
provide a language-based user interface operable by a non-expert user, and, in response to additional input of a natural-language instruction by the user, reconfigure the processing procedures and automatically perform extension or modification of a task.

### Supplementary 2

The system according to supplementary 1,
wherein the processor is configured to, when a type of target digital data, acquisition conditions, and a storage structure are specified in the analysis result obtained from the generative AI model, automatically acquire the target digital data from an information source on the communication network, organize and store the target digital data in a plurality of storage units within a storage area in accordance with logical classification criteria, form a table-of-contents generation prompt sentence for the generative AI model using the target digital data or the summarization result as input information, and generate table-of-contents information corresponding to a document structure by using the generative AI model.

### Supplementary 3

The system according to supplementary 1,
wherein the processor is configured to provide, to the terminal, a user interface that displays the natural-language instruction, a processing state, and the summarization result in a dialog format, integrate additional natural-language instructions input by the user into a history included in a prompt sentence to be input to the generative AI model, automatically generate a new processing procedure based on a response from the generative AI model, and perform addition, modification, or reprioritization of processing contents for an existing task, thereby enabling extension of task contents without requiring specialized knowledge from the user.

### Application Example 2

### Supplementary 1

A system comprising a processor,
wherein the processor is configured to
receive a user instruction expressed in natural language, input a prompt sentence to a generative AI model in order to extract a task content and a task condition from the natural language, and generate analysis result data as structured data based on an output of the generative AI model,
identify a plurality of tasks including at least one acquisition process for an information resource and at least one control process for a device resource based on the structured data,
determine an execution procedure for each of the plurality of tasks, and generate an additional prompt sentence for the generative AI model so as to supplement a content or the execution procedure of the plurality of tasks,
estimate an emotional state of a user by using at least one of voice information, image information, and character information of the user, calculate a control parameter for dynamically changing a priority or an execution method of the plurality of tasks according to the emotional state, and adjust an execution order or a presentation format of the plurality of tasks in accordance with the control parameter,
acquire digital information from at least one of an information storage apparatus and a communication apparatus according to the identified plurality of tasks, organize the digital information based on classification information and hierarchy information, and generate structured information including at least one of table-of-contents information and recommendation information, and
generate response information to be displayed or output by a user interface apparatus based on the structured information and the emotional state, and transmit the response information to a terminal apparatus.

### Supplementary 2

The system according to supplementary 1,
wherein the processor is configured to
acquire the digital information as an electronic document or recorded data from an external information source via a communication network, automatically place the electronic document or the recorded data in a predetermined storage area within the information storage apparatus by executing a file operation process, and generate the table-of-contents information based on structural information of the electronic document or the recorded data.

### Supplementary 3

The system according to supplementary 1,
wherein the processor is configured to
cause the user interface apparatus to provide an interactive interface that accepts the user instruction only by the natural language, and cause the generative AI model to automatically generate the prompt sentence according to the user instruction so that a new task type or a new processing procedure is addable, thereby enabling a user without specialized knowledge to expand a task content.

What is claimed is:

1. A system comprising:
circuitry configured to:
receive a natural language instruction from a terminal apparatus via a packet-switched network;
construct a first parameterized instruction sequence based on the natural language instruction, and provide the first parameterized instruction sequence to a generative neural network model to cause the generative neural network model to analyze the natural language instruction and generate structured task information representing a decomposed content of the natural language instruction;
execute an information acquisition process based on acquisition conditions included in the structured task information, the information acquisition process including searching digital data stored in an information storage device via an application program interface and acquiring metadata and content data of the digital data; and
organize the acquired digital data into a predetermined storage area in accordance with classification conditions included in the structured task information.

2. The system according to claim 1, wherein the circuitry is further configured to:
extract title information and at least a portion of content data from each piece of digital data in the storage area, construct a second parameterized instruction sequence based on the extracted information, and provide the second parameterized instruction sequence to the generative neural network model to generate table-of-contents data in a markup format.

3. The system according to claim 2, wherein the circuitry is further configured to:
record the table-of-contents data in the storage area as a structured index file, and generate a notification message including the structured index file and location information of the storage area, and transmit the notification message to the terminal apparatus via a communication protocol.

4. The system according to claim 3, wherein the circuitry is further configured to:
estimate an emotional state of the entity based on expression data included in the natural language instruction and usage pattern data acquired from the terminal apparatus, and dynamically adjust at least one of an acquisition order of the digital data, an organization method of the digital data, and a content of the table-of-contents data generation in accordance with the estimated emotional state.

5. The system according to claim 4, wherein the emotional state estimation comprises applying a sentiment analysis model to the natural language instruction to classify the instruction into one of a plurality of emotional state categories, and mapping the emotional state category to a priority adjustment parameter and an execution method selection parameter.

6. The system according to claim 1, wherein the structured task information includes at least a task type identifier, one or more acquisition condition parameters specifying data source identifiers and query patterns, one or more classification condition parameters specifying category labels and sorting criteria, and one or more notification condition parameters specifying delivery timing and format.

7. The system according to claim 6, wherein the circuitry is further configured to:
register the structured task information as an executable task sequence in a task management data structure stored in a storage medium, and automatically execute the task sequence in response to a triggering condition without requiring additional configuration from the entity.

8. The system according to claim 7, wherein the circuitry is further configured to:
each time a new natural language instruction is received, construct a new parameterized instruction sequence, generate updated structured task information, and modify or extend the executable task sequence based on the updated structured task information.

9. The system according to claim 1, wherein the information acquisition process comprises transmitting query requests to a plurality of information sources via the packet-switched network using respective application program interfaces, receiving response data from the plurality of information sources, and aggregating the response data into the predetermined storage area.

10. The system according to claim 9, wherein the circuitry is further configured to:
selectively acquire digital data corresponding to a predetermined file type specification included in the acquisition conditions, and aggregate the selectively acquired digital data into a single folder within the storage area using a file system management function.

11. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

12. The system according to claim 11, wherein the first parameterized instruction sequence includes a task decomposition directive instructing the generative neural network model to parse the natural language instruction into a hierarchical structure of sub-tasks, each sub-task having a task type, input parameters, and output specifications.

13. The system according to claim 12, wherein the circuitry is further configured to:
acquire visual information of a physical object using an imaging device or a code reading device, perform an identification process on the visual information to generate structured object information including an object identifier and attribute data, and integrate the structured object information with the acquired digital data as a unified data set.

14. The system according to claim 13, wherein the circuitry is further configured to:
execute database processing on the unified data set including updating attribute information, calculating quantity values, assigning classification labels, and extracting newly added entries, and construct a parameterized instruction sequence based on the database processing results to cause the generative neural network model to generate summary report data.

15. The system according to claim 1, wherein the circuitry is further configured to:
acquire image data from an imaging device and acoustic data from an acoustic transducer associated with the terminal apparatus, extract visual feature data and acoustic feature data, apply an emotion estimation model comprising a multi-layer neural network to a combined feature vector derived from the visual feature data and the acoustic feature data to compute emotion classification data.

16. The system according to claim 15, wherein the circuitry is further configured to:
incorporate the emotion classification data into the parameterized instruction sequence to cause the generative neural network model to adapt the tone, detail level, and prioritization of generated content based on the estimated emotional state.

17. The system according to claim 1, wherein the circuitry is further configured to:
provide an operation interface on the terminal apparatus that accepts the natural language instruction without requiring specialized technical knowledge from the entity, and automatically perform generation of the parameterized instruction sequence and extension of processing procedures based on the structured task information in response to receiving the natural language instruction.

18. A system comprising:
circuitry configured to:
receive, via a communication interface coupled to a packet-switched network, a natural language instruction from a terminal apparatus;
construct a parameterized instruction sequence based on the natural language instruction, and provide the parameterized instruction sequence to a generative neural network model having a transformer-based architecture including a plurality of self-attention layers to generate structured task information;
execute an information acquisition process based on the structured task information by querying information sources via application program interfaces to acquire digital data;
organize the acquired digital data into a storage area according to classification conditions in the structured task information;
extract content data from the organized digital data, construct a supplementary parameterized instruction sequence, and provide it to the generative neural network model to generate table-of-contents data; and
estimate an emotional state of the entity and dynamically adjust task execution parameters based on the estimated emotional state.

19. The system according to claim 18, wherein the circuitry is further configured to:
register the structured task information as an executable task sequence, automatically execute the task sequence upon triggering conditions, and extend or modify the task sequence in response to subsequent natural language instructions without requiring additional technical configuration.

20. A method performed by circuitry, the method comprising:
receiving a natural language instruction from a terminal apparatus via a packet-switched network;
constructing a first parameterized instruction sequence based on the natural language instruction, and providing the first parameterized instruction sequence to a generative neural network model to cause the generative neural network model to analyze the natural language instruction and generate structured task information representing a decomposed content of the natural language instruction;
executing an information acquisition process based on acquisition conditions included in the structured task information, the information acquisition process including searching digital data stored in an information storage device via an application program interface and acquiring metadata and content data of the digital data; and
organizing the acquired digital data into a predetermined storage area in accordance with classification conditions included in the structured task information.
